(19) United States
(12) Patent Application Publication
(10) Pub. No.: US 2024/0306629 A1
(43) Pub. Date: Sep. 19, 2024

(54) SPRAYER NOZZLE MONITOR AND CONTROL SYSTEM AND METHODS FOR SAME

(71) Applicant: Raven Industries, Inc., Sioux Falls, SD (US)

(72) Inventors: Jared Ernest Kocer, Sioux Falls, SD (US); Travis Allen Burgers, Sioux Falls, SD (US); Nicholas O. Michael, Sioux Falls, SD (US)

(21) Appl. No.: 18/575,725

(22) PCT Filed: May 4, 2022
(86) PCT No.: PCT/US2022/027707

§ 371 Date: Dec. 29, 2023

Related U.S. Application Data
(60) Provisional application No. 63/217,755, filed on Jul. 1, 2021.
(60) Provisional application No. 63/254,466, filed on Oct. 11, 2021.

(51) Int. Cl. A01M 7/00

(52) U.S. Cl. CPC A01M 7/0096

(57) ABSTRACT

A sprayer nozzle assembly control system includes a modulating nozzle assembly having a control valve and a spray tip. At least one spray modulation actuator is included with one or both of the control valve or the spray tip, and the spray modulation actuator is configured to control an actual spray profile of a sprayed agricultural product. A spray sensor is configured to monitor the actual spray profile of the spray tip and is in communication with the spray sensor. The nozzle assembly controller controls the actual spray profile and includes a comparator to compare the actual spray profile with a specified spray profile and generate a spray profile deviation. The nozzle assembly controller includes a spray modulation interface in communication with the at least one spray modulation actuator, and the spray modulation interface directs actuation of the at least one spray modulation actuator to modulate the actual spray profile.

### CROSS-REFERENCE TO RELATED PATENT DOCUMENTS

This patent application is also related to U.S. application Ser. No. 16/476,069 filed Jul. 3, 2019 and entitled CONFIGURABLE NOZZLE ASSEMBLY AND METHODS OF SAME; incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Raven Industries, Inc. of Sioux Falls, South Dakota, USA. All Rights Reserved.

### TECHNICAL FIELD

This document pertains generally, but not by way of limitation, to the sprayed application of agricultural products (fluid or gaseous).

### BACKGROUND

Agricultural sprayers are used to distribute agricultural products, such as fertilizers, insecticides, herbicides and fungicides to crops. Agricultural sprayers include one or more sprayer booms that are long enough (e.g., 60 feet to 150 feet) to spray multiple rows of crops in a single pass. Each of the sprayer booms include multiple sprayer nozzles to distribute an agricultural product in a spray pattern.

Agricultural sprayers include a reservoir for a carrier fluid. The carrier fluid is used as a vehicle to carry and distribute one or more injection products or additives dispersed into the carrier substance, for instance herbicides, pesticides, fertilizers or the like to provide an agricultural product. The reservoir communicates the agricultural product to the multiple sprayer nozzles with intervening boom tubes.

In some examples, each spray nozzle includes a control valve and an associated spray tip. The control valve provides a specified flow rate of the carrier fluid and an injection product (collectively an agricultural product) to the spray tip. In other examples, the control valve is operated to open and close based on a duty cycle (e.g., opening and closing segments per unit time, such as per second). The spray tip of the sprayer nozzles is configured to apply the agricultural product from the control valve with a spray pattern. In operation, the control valve provides the specified flow rate of the agricultural product for spraying from the spray tip. For instance, the control valve is operated with a duty cycle intended to deliver the specified flow rate of agricultural product to the spray tip.

### SUMMARY

The present inventors have recognized, among other things, that a problem to be solved can include detecting and addressing inconsistencies in the application of agricultural products in a spray pattern. For example, wind causes a perturbation of sprayed agricultural product referred to as spray drift. The spray droplets are blown outside of a specified spray pattern and accordingly fail to contact (or poorly contact) a target such as a crop, weed, pest, ground or the like. In other examples, the sprayed agricultural product may have a beneficial effect for a specified crop and have detrimental effects for other crops in adjacent fields. Accordingly, spray drift of the agricultural product should be minimized.

In other examples, agricultural product is applied with varied droplet sizes to address a first issue, such as spray drift. An operator may adjust spray tips or other sprayer settings to generate spray droplets as desired based on their application conditions and design constraints of the spray tip. The operator for instance may adjust parameters to create larger spray droplets. The larger spray droplets have increased mass and are less affected by wind that may otherwise promote spray drift. The large spray droplets provide decreased coverage in some circumstances. For instance, the large droplets deflect from leaves, stalks or the like of targets (e.g., crops, weeds or the like). In contrast, the operator may choose to create smaller spray droplets, as smaller droplets provide a corresponding finer spray, and the droplets adhere to leaves or stalks more readily that larger droplets. In other examples, a spray pattern generally includes a specified arc that ideally emanates from a spray tip and fills the specified arc with a continuous spray of droplets. A spray pattern including larger spray droplets may, in some examples, include gaps in the spray pattern that are otherwise filled with finer (smaller) droplets.

In still other examples, spray patterns are set by an operator, for instance through selection of spray tips, manual setting of spray tips, application pressure or the like and based on a specified flow rate to provide a specified spray pattern for a static target height (e.g., of the crop, weed, ground or the like) and a static boom height. However, weeds, plants and the like vary in height, sometimes considerably. Additionally, boom heights change by inches or feet (especially proximate the distal ends of spray booms) because of variations in terrain, inclination or declination of the terrain or the like that cause angular movement of spray booms and the associated spray tips. Accordingly, a preset specified spray pattern may be inadequate to provide the specified coverage with various height changes.

As noted above, the operating environment of the agricultural sprayer is dynamic. Variations in height in the field affect coverage because a preset spray pattern is based on static heights, and in practice the boom height and target height are dynamic and can vary considerably. Additionally, environmental conditions dynamically change, and a relatively small droplet size and corresponding settings for a calm operating environment are not sufficient as weather conditions change, the sprayer reaches the crest or top of a hill (where higher winds are more typical) or the like. Conversely, relatively large droplets sizes may provide poor target coverage because of deflection, poor filling of a spray pattern or the like and may be unnecessary for application in calm winds or while agricultural sprayer travels in the lee of a hill. Further, in most examples an operator cannot reasonably arrest or slow operations to adjust droplet size (including the varied characteristics that affect droplet size), spray patterns or the like and at the same time efficiently conduct agricultural operations. For instance, tuning spray tips to different droplet sizes, spray patterns or the like often requires manual setting of each spray tip by the operator, and agricultural sprayers often have dozens of spray tips that require manual setting. Accordingly, operators often manually set spray tips at droplet sizes, spray patterns or the like that are less than ideal, but intended to partially compensate for at least some environmental affects (e.g., winds, terrain variation, crop or weed height variation or the like). In some examples, the less than ideal settings waste agricultural product, provide poor application coverage or both.

The present subject matter can help provide a solution to these problems, for instance with the example sprayer nozzle assembly control systems discussed herein (referred to in some places as a “control system”). The control system includes a nozzle assembly controller in communication with one or more spray sensors. The spray sensors include, but are not limited to, cameras, video cameras, ultrasound, laser, LIDAR, radar or the like that observe the actual spray profile emanating from one or more spray tips of modulating (e.g., automatically controlled) spray nozzle assemblies. For instance, the spray sensors and control system measure one or more of droplet size (including ranges of sizes, ratios of sizes or the like), droplet kinematics (e.g., position, direction, speed, acceleration or the like) and droplet position (e.g., relative to a specified spray pattern) of the actual spray profile. For example, the nozzle assembly controller includes an identification module that identifies droplets within an actual spray profile and a tracking module that determines kinematics of the identified droplets, for instance with comparison of the droplets in two or more images.

The nozzle assembly controller includes a comparator that compares the actual spray profile (e.g., having one or more of the characteristics described herein) with a corresponding specified spray profile. The specified spray profile is a threshold or benchmark that facilitates determination of a deviation in one or more characteristics of the actual spray profile. In one example, the specified spray profile includes one or more of a specified spray pattern, droplet size(s), droplet kinematics, specified boom height, specified target height (e.g., of the crop, weed or ground) set by an operator, equipment manufacturer or the like to provide a specified application of an agricultural product. Optionally the control system includes a library, database or algorithm that provide specified spray profiles based on the agricultural product applied, target height (or range), boom height (or range), application pressure, flow rate or the like.

The comparator determines deviations in the actual spray profile from the specified spray profile, such as kinematic deviations, droplet size deviations, spray pattern deviations, deviations in one or both of boom height or target height or the like. A spray modulation interface of the nozzle assembly controller determines one or more instructions for spray modulation actuators that guide the actual spray profile of the sprayed agricultural product toward compliance with the specified spray profile.

The spray modulation actuators include one or more components of modulating nozzle assemblies or components in communication with the assemblies. The spray modulation actuators include, but are not limited to, pumps (e.g., system pumps, intermediate pumps or the like configured to pump the agricultural product), pre-orifices (e.g., a control valve of the nozzle assembly, an actuated orifice plate(s) or the like), gas inductors, modulating spray tips, modulating accumulators or the like. The nozzle assembly controller provides one or more control instructions to the corresponding spray modulation actuators (e.g., motors, stepper motors or the like that control the movable features of the spray modulation actuators that affect nozzle performance including droplet size, pattern or the like). As discussed herein, spray modulation actuators include features associated with the nozzle assemblies that provide control of one or more characteristics of the actual spray profile (e.g., droplet size droplet kinematics, spray pattern or the like). Modulation, as used herein, includes, but is not limited to, controlled movement, position, operation or the like of features associated with the spray modulation actuators control characteristics of the actual spray profile including changing characteristics, maintaining characteristics or the like. Modulation may include, in one example, the reciprocating operation of a pre-orifice type actuator such as a flow rate control valve using pulse width modulation control (e.g., duty cycle, duty cycle frequency or the like). However, modulation in the present application is not limited to this format of control. Other examples of modulation or modulated control include, but are not limited to, graduated control of nozzle fittings, orifice plates, gas inductors, accumulators or the like between open and closed positions as well as intermediate positions to control aspects of actual spray profiles from the nozzle assemblies.

In some examples, the modulating nozzle assemblies or sprayer systems include a subset of the spray modulation actuators described herein, for instance one or more of the actuators, and the control instructions are provided based on the spray modulation actuators available for control. In other examples the control instructions are provided with associated weights or priorities, for instance provided by operator selection, algorithm control or the like, that modulate the magnitude of the control instructions and corresponding implementation at the spray modulation actuators to control the actual spray profile. For instance, a pre-orifice and associated pressure control in one example is provided a higher priority (potentially with an associated higher weight) for control of droplet size relative to a modulating spray tip, while a gas inductor and the associated flow rate of supplemental gas is given a higher priority than a modulating accumulator having a volume change. In other examples, multiple spray modulation actuators, when multiple actuators are provided with the system, are operated in concert (optionally according to weighting or priority) to cooperatively address spray profile deviations and guide output toward the specified spray profile. For example, the pre-orifice is modulated (e.g., controlled to varying degrees of open, closed, and intermediate positions therebetween) to provide the specified droplet size and the modulating spray tip (where present) is modulated to provide the specified spray pattern.

The spray modulation actuators in combination with the nozzle assembly controller and spray sensors permit ongoing automated control of sprayer performance in response to various factors that otherwise negatively affect sprayer performance. For instance, spray drift caused by wind is detected with tracking of droplet kinematics, position or the like. Detected spray drift is, in one example, addressed with active control to increase droplet size. In other examples, the nozzle assembly controller optionally minimizes spray output at the peripheral modulating nozzle assemblies (including a flow rate of zero) to decrease peripheral spray drift, increases flow rate at the interior modulating nozzle assemblies, and in some examples increases the spray pattern and decreases the droplet size with the interior modulating nozzle assemblies to compensate for the decreased output at the periphery. The larger spray pattern and smaller droplet sizes are readily applied to target crops, weeds, pests, ground or the like from the interior nozzle assemblies that are proximate to the peripheral nozzle assemblies (having arrested or decreased spray) while drift of the product away from the sprayer is minimized.

In other examples, deflection of agricultural product at the target (e.g., canopy, leaves, stalks or the like) is detected with tracking of droplet kinematics including scattering proximate to the target. Deflection is, in one example, addressed with control of one or more spray modulation actuators to decrease droplet size. The smaller droplets more readily adhere to the target, and the spray sensors note the enhanced adherence with continued monitoring of the droplet kinematics. If deflection persists the nozzle assembly controller further decreases droplet size to enhance adherence.

In an example including a deviation in height, such as spray boom height, target height or the like measured with the spray sensor (including an optional sensor, such as an ultrasound, radar or LIDAR sensor), the comparator determines a spray profile deviation based on a specified height(s) relative to actual height(s). In one example, the nozzle assembly controller provides control instructions to the modulating spray tips of the modulating nozzle assemblies to control the spray pattern based on the detected deviation(s) in height. For example, if the sprayer boom angles upwardly the spray nozzles proportionally angle upward and elevate relative to a specified boom height. The rise of the spray nozzles is compensated with the nozzle assembly controller and the associated modulating spray tip providing a tighter (smaller arc) spray pattern to direct the agricultural product toward the target crop, weed, pest, or ground. Conversely, as the spray boom angles down the spray nozzles fall below a specified boom height and the nozzle assembly controller modulates the modulating spray tip to provide a larger (wider arc) spray pattern to enhance coverage of the target crop, weed, pest or ground.

The spray nozzle assembly control system described herein including the nozzle assembly controller, spray sensors, and modulating nozzle assemblies provides an automated system that monitors actual spray profiles of an agricultural sprayer, determines deviations in the actual spray profile relative to a specified spray profile and then actively controls nozzle assembly performance to guide the actual spray profile toward the specified spray profile. The sprayer nozzle assembly control system monitors sprayer performance and guides actual spray performance toward a specified spray profile sprayer while the agricultural sprayer conducts continuous operation (e.g., with a human operator, remote operator or automated operator). Interruption of operation to laboriously change sprayer settings or continued operation that wastes or misapplies agricultural product are thereby minimized (e.g., decreased or eliminated).

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view of one example of an agricultural sprayer.

FIG. 2 is a schematic view of the agricultural sprayer of FIG. 1.

FIG. 3A is a schematic view of one example of a modulating nozzle assembly.

FIG. 3B is a perspective view of another example of a modulating nozzle assembly.

FIG. 4A is a perspective view of one example of a modulating sprayer tip.

FIG. 4B is an exploded view of the modulating sprayer tip of FIG. 4A.

FIG. 4C is a perspective view of another example of a modulating sprayer tip having a modulating orifice and pre-orifice.

FIG. 5 is a schematic view of one example of a nozzle assembly spray pattern having a specified spray profile.

FIG. 6 is series of time lapsed views of droplets in a monitoring section of a sensed actual spray profile showing identification and tracking of sprayer droplets.

FIG. 7A is a schematic view of the modulating nozzle assembly of FIG. 4A including an example of spray drift.

FIG. 7B is a schematic view of the modulating nozzle assembly of FIG. 4A including an example of target deflection.

FIG. 7C is a schematic view of the modulating nozzle assembly of FIG. 4A including an example of droplet size deviation.

FIG. 7D is a schematic view of the modulating nozzle assembly of FIG. 4A including an example of spray pattern deviation.

FIG. 8 is a schematic view of an example of the sprayer nozzle assembly control system.

FIG. 9 is a table of example parameter changes for modulating nozzle assemblies including one or more spray modulation actuators.

FIG. 10 is a block diagram illustrating an example of a computing system including one or more modulating nozzle assemblies and that implements a sprayer nozzle assembly control system.

### DETAILED DESCRIPTION

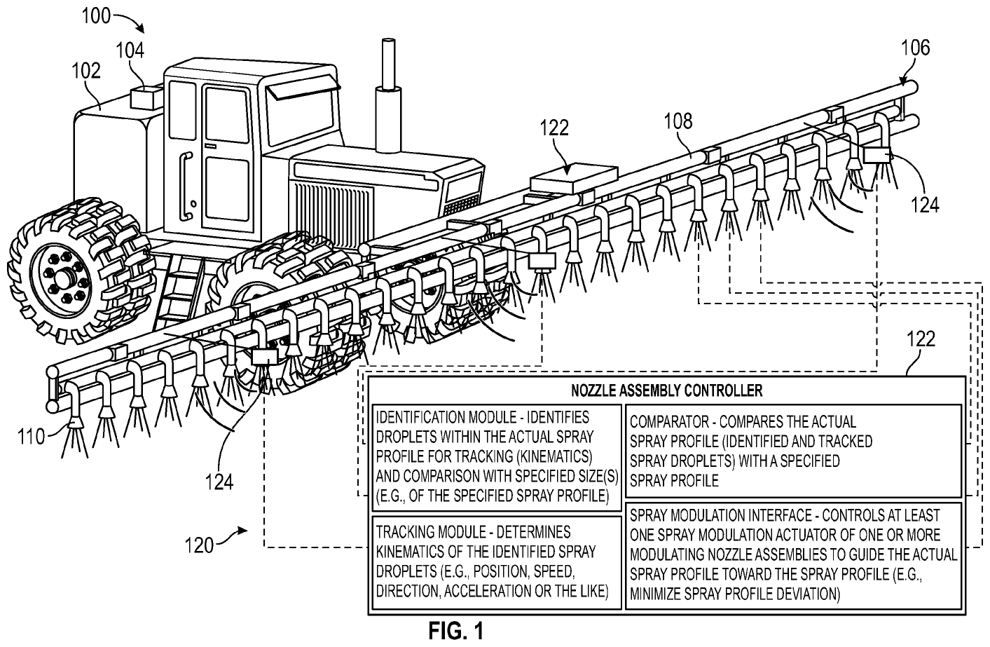

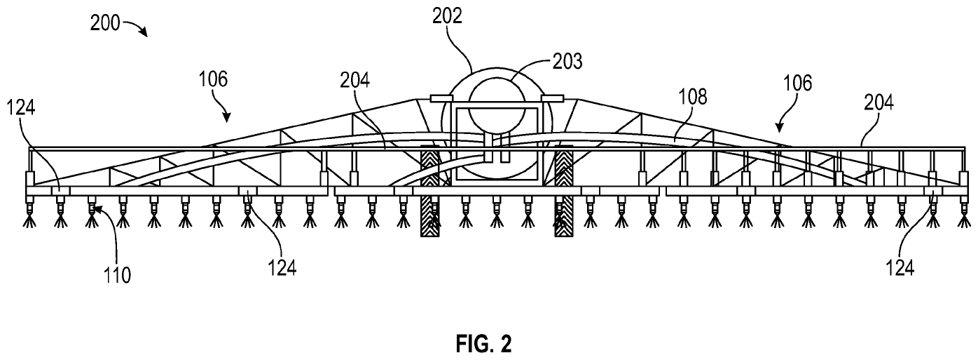

FIG. 1 is a perspective view of one example of a sprayer nozzle assembly control system 120 provided with an agricultural sprayer 100. The agricultural sprayer 100 includes an agricultural product reservoir 102. The agricultural product reservoir 102 includes one or more of a carrier fluid reservoir (e.g., for water, a base agricultural product or the like), an injection product reservoir(s) (e.g., for additives to add to the carrier fluid for modulation of composition and concentration), premixed agricultural product reservoir or the like. A pump 104 is in communication with the agricultural product reservoir 102. The pump 104 includes one or more of a system pump, intermediate pumps (e.g., associated with booms or portions of booms and the associated nozzles) or the like. The pump 104 pressurized and distributes the agricultural product of carrier fluid and injection products to the sprayer booms 106 for application through spray nozzles 110, such as the modulating nozzle assemblies described herein. In other examples, for instance as shown in FIG. 2, the pump 104 includes multiple pumps configured to separately supply the carrier fluid and the one or more injection products to the sprayer boom for localized injection of the injection products to the carrier fluid at the sprayer booms 106, subsets of the spray nozzles 110, or at each of the spray nozzles 110.

As further shown in FIG. 1, the sprayer booms 106 include spray nozzles 110. The spray nozzles 110 apply the agricultural product in a spray pattern having specified droplet sizes (e.g., diameter, profile, unitless numbers or the like corresponding to the size of droplets). The spray nozzles 110 include modulating spray nozzles (or modulating nozzle assemblies) as described herein configured to control one or more characteristics of an actual spray profile including, but not limited to, droplet size, spray pattern, droplet kinematics (e.g., through droplet size or pattern control) or the like. The modulating spray nozzles includes a control valve (e.g., solenoid operated poppet, butterfly valve, needle valve, ball valve or the like), a spray tip and at least one spray modulation actuator that provides ongoing control (e.g., maintenance or change) of the actual spray profile, for instance to minimize spray profile deviation relative to a specified spray profile. The spray modulation actuators include, but are not limited to, modulating spray tips, pre-orifices (e.g., control valves, orifice plates or the like), accumulators, gas inductors or the like to provide modulating control (e.g., automatic control) of the spray profile. The spray nozzles 110 are, in one example, components of the sprayer nozzle assembly control system 120.

An example of the sprayer nozzle assembly control system 120 is shown in FIG. 1. The system 120 includes a nozzle assembly controller 122 in communication with the spray nozzles, such as the modulating nozzle assemblies 110. Additionally, one or more spray sensors 124 are provided with the system 120 and configured to observe actual spray profiles of the agricultural product emanating from the nozzle assemblies 110. As described herein, the nozzle assembly controller 122 analyzes one or more sections or portions of observations made with the spray sensor 124 to minimize processing load, focus on known zones of spray profile deviation or the like. The spray sensors 124 are provided at one or more locations relative to the spray nozzles 110 to observe at least one (potentially multiple) actual spray profiles. As shown in FIG. 1, multiple spray sensors 124 are provided along the sprayer boom 106 to permit observation of actual spray profiles at interior and peripheral (outlying) locations along the boom 106.

In addition to observing the actual spray profile, the spray sensor 124 in some examples monitors one or more of spray boom height (relative to a target or reference, such as crops, ground or the like), target height (relative to the spray boom or ground) or the like. The spray sensor 124 include, but are not limited to, cameras, video cameras, ultrasound sensors, laser, LIDAR, radar or the like with the capability of observing the actual spray profile and identifying droplets and their size; tracking movement of the droplets; assessing spray profile shape, arc or the like.

The spray sensors 124 are in communication with the nozzle assembly controller 122, and the controller 122 is in control with the modulating nozzle assemblies 110. The nozzle assembly controller 122 includes a comparator configured to determine deviations of one or more actual spray profiles relative to a specified spray profile(s). The nozzle assembly controller 122 operates the modulating nozzle assemblies 110 and controls spray modulation actuators associated with the modulating nozzle assemblies to change actual spray profiles, for instance based on the determined deviation. Optionally, the nozzle assembly controller 122 includes a plurality of nozzle assembly controllers associated with one or a subset of the modulating nozzle assemblies 110.

In the example architecture shown in FIG. 1, the nozzle assembly controller 122 includes an identification module, and the identification module identifies droplets within the actual spray profile (or profiles) observed with the spray sensors 124. The identification module identifies droplets, for instance discriminating between droplets to permit tracking of the droplets between successive observations (e.g., images, scans or the like) from a sensor 124. Additionally, the identification module is configured to determine the size of identified droplets.

In the example system 120, the nozzle assembly controller 122 tracks identified droplets with a tracking module. The tracked droplets have associated kinematics determined, in one example, with position indexing between two or more observations and associated vector calculations. Derivation of the vectors permits additional determination of additional characteristics including, but not limited to, acceleration, forces (with acceleration and mass of droplets based size determination) or the like.

The nozzle assembly controller 122 further includes a comparator that compares the actual spray profile of the identified and tracked spray droplets with a specified spray profile having one or more of a specified droplet size (including range of sizes), specified kinematic characteristics (e.g., position, speed, acceleration or the like) and spray pattern or the like. The comparison provides a spray profile deviation of the actual spray profile relative to the specified spray profile. The spray profile deviation in various examples includes one or more determined values (component deviations) including deviation in droplet size, deviation in droplet kinematics, deviation of the spray pattern or the like having unit quantities (e.g., dimensions, kinematics, degrees, respectively). In other examples, the component deviations are unitless to permit weighted combination of the component deviations into an overall spray profile deviation value.

The determined spray profile deviation is provided to the spray modulation interface of the nozzle assembly controller 122 to initiate control of at least one spray modulation actuator of one or more modulating nozzle assemblies 110 to guide the actual spray profile toward the specified spray profile (e.g., minimize spray profile deviation). As discussed herein the modulating nozzle assemblies 110 include one or more spray modulation actuators including, but not limited to, the control valve (as an example of a pre-orifice), a modulating spray tip, a modulating accumulator, a gas inductor or the like. The spray profile deviation corresponds to one or more control instructions that operate the actuators, for instance to maintain the actual spray profile (e.g., if there is minimal or no deviation) or adjust the actual spray profile including changing of droplet size, spray pattern or the like to decrease the deviation between the specified spray profile and the actual spray profile. In one example, the observation, assessment of deviation and implementing of control of the one or more spray modulation actuators is conducted with feedback control. In another example, the nozzle assembly controller 122 provides different control instructions to each of the modulating spray nozzle assemblies 110 (including subsets of assemblies) based on the actual spray profile observed for the respective assemblies.

FIG. 2 is another example of an agricultural sprayer 200 configured for use with the sprayer nozzle assembly control system 120. In this example, the sprayer 200 includes sprayer booms 106 and boom tubes 108 in communication between a carrier fluid reservoir 202 and the modulation nozzle assemblies 110 provided along the sprayer booms 106. Additionally, this example sprayer 200 includes one or more injection product reservoirs 203 having a quantity of injection product for controlled introduction to the carrier fluid. As shown in FIG. 2 the injection product boom tubes 204 extend from the injection product reservoir 203 through the injection product boom tubes 204 to the modulating nozzle assemblies 110. The injection product, separated from the carrier fluid by the boom tubes 202, 203, is then injected locally to the carrier fluid to provide one or more of composition or concentration control for one or more injection products at the modulating nozzle assemblies 110.

In a similar manner to the sprayer 100, the agricultural sprayer 200 includes a sprayer nozzle assembly control system 120 including a nozzle assembly controller 122 in communication with one or more of the modulating spray assemblies 110. As further shown in FIG. 2, one or more spray sensors 124 are provided proximate to the modulating nozzle assemblies 110. The spray sensors 124 are configured to observe one or more actual spray profiles emanating from the modulating nozzle assemblies 110 and provide the observations of the actual spray profile to the nozzle assembly controller 122. The nozzle assembly controller 122 identifies one or more droplets, the spray pattern or the like of the actual spray profile and provides one or more spray modulation actuation control instructions to the modulating spray nozzle assemblies 110 to address deviation of the actual spray profile relative to a specified spray profile. Optionally, the nozzle assembly controller 122 provides different control instructions to each of the modulating spray nozzle assemblies 110 (including subsets of assemblies) based on the actual spray profile observed for the respective assemblies.

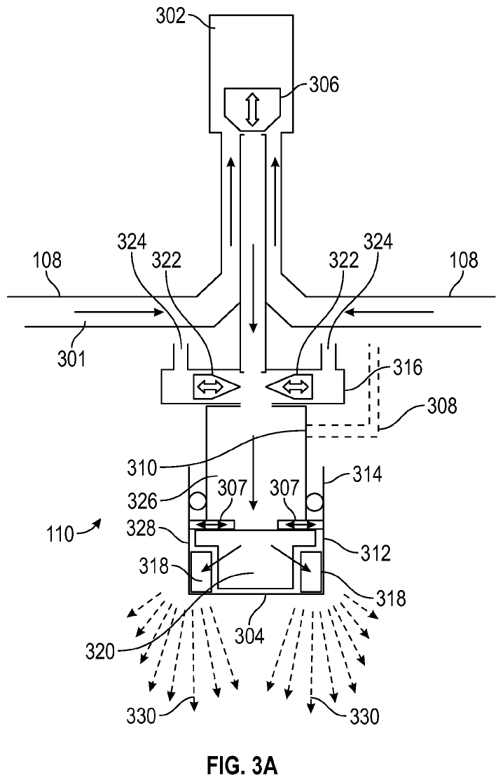

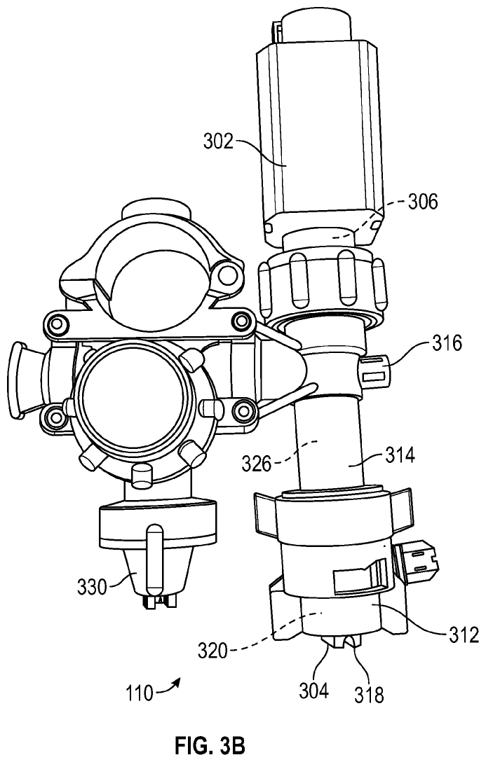

FIG. 3A is a schematic view of one example of a modulation nozzle assembly 110, and FIG. 3B is a companion perspective view of the assembly 110. The nozzle assembly 110 includes a spray tip 304, a control valve 302, and one or more spray modulation actuators. An agricultural product 301 (one or more of carrier fluid, injection product or mixed carrier fluid with injection product) is provided along the boom tube 108 to each of the modulating nozzle assemblies 110. As shown in FIG. 3, the agricultural product is provided to the assembly 110 through the control valve 302. For instance, the valve operator 306 is selective opened and closed (e.g., according to a duty cycle, operating frequency or the like) to provide a specified flow rate of the agricultural product to the spray tip 304 for application to a target such as a crop, ground, pest, weed or the like. In another example, the modulating nozzle assembly 110 includes a supplemental nozzle assembly 330 in communication with the carrier fluid, agricultural product or separate reservoirs of carrier fluid and injection product. The supplemental nozzle assembly 330 is an optional second nozzle that provides a supplemental spray pattern of the agricultural product or, optionally, a different agricultural product than that provided from the spray tip 304. In other examples, the supplemental nozzle assembly 330 provides a base flow rate of the agricultural product and the modulating nozzle assembly 110 (including the spray modulation actuators) provides a controlled (e.g., varied droplet size, spray pattern or the like) application of the agricultural product.

In another example, the modulating nozzle assembly 110 includes an injection assembly configured to administer one or more injection products (e.g., additives) to a carrier fluid provided through the boom tube 108. The injection assembly includes an injection line 308 in communication with the modulating nozzle assembly 110 at an injection port 310. An injection control valve controls the flow of the injection product to corresponding control the concentration of the injection product in the carrier fluid, the resulting composition and concentration of the agricultural product or the like. As shown in FIG. 3, the injection is proximate to the assembly 110 and the spray tip 304, and accordingly localizes mixing of the agricultural product in a manner to ensure rapid application of a specified composition and concentration of the injection product to the target.

In this example the modulating nozzle assembly 110 includes one or more spray modulation actuators configured to control one or more of droplet size, spray pattern or the like (e.g., the actual spray profile). The nozzle assembly 110 may include a plurality of these actuators such as, but not limited to, the orifice (e.g., the modulating spray tip 312), modulating accumulator 314, gas inductor 316, or the control valve 302. Optionally, where two or more spray modulation actuators are included with the modulating nozzle assembly 110 these actuators cooperate with each other to control droplet size or alternatively control a different characteristic (e.g., spray pattern). For instance the control valve 302 is operated to control droplet size while the modulating spray tip 312 is operated to control the spray pattern.

The nozzle assembly controller 122 provides one or more control instructions to the corresponding spray modulation actuators (e.g., motors, stepper motors or the like that control the movable features of the spray modulation actuators that affect nozzle performance including droplet size, pattern or the like). As discussed herein, spray modulation actuators include features associated with the nozzle assemblies that provide control of one or more characteristics of the actual spray profile (e.g., droplet size droplet kinematics, spray pattern or the like). Modulation, as used herein, includes, but is not limited to, controlled movement, position, operation or the like of features associated with the spray modulation actuators to control characteristics of the actual spray profile including changing characteristics, maintaining characteristics (e.g., while other characteristics, like pressure or flow rate, change) or the like. In one example, modulation or modulated control includes, but is not limited to, graduated control of nozzle fittings, orifice plates, gas inductors, accumulators or the like between open and closed positions as well as intermediate positions to control aspects of actual spray profiles from the nozzle assemblies. In another example, modulation may include the reciprocating operation of a pre-orifice type actuator such as a flow rate control valve using pulse width modulation control (e.g., duty cycle, duty cycle frequency or the like).

Referring again to the control valve 302 of the modulating nozzle assembly 110, the valve operator 306 includes one or more of a solenoid operated poppet, butterfly valve, needle valve or the like. In some examples the control valve provides flow rate control and is also an example of a spray modulation actuator. For instance, the control valve 302 is operated as a pre-orifice to the nozzle assembly 110 and the spray tip 304 to control pressure (e.g., control droplet size) through variation in the valve opening, duty cycle, duty cycle frequency (number of open and close instances per unit time) or the like. For example, increasing one or more of the opening of the control valve 302, duty cycle (percent open), duty cycle frequency or the like minimizes pressure drop across the valve 302, and thereby decreases the droplet size from the spray tip and the spray pattern droplets are finer. Conversely, decreasing one or more of opening of the control valve 302, the duty cycle, duty cycle frequency or the like increases pressure drop across the valve 302 and thereby increases the droplet size from the spray tip making the spray pattern droplets coarser.

Another example of a pre-orifice actuated as a spray modulation actuator includes one or more orifice plates 307 shown in FIG. 3A. The orifice plates 307 are selectively opened, closed (e.g., fully closed to shut off spray), including intermediate positions therebetween to control pressure (pressure drop) and corresponding droplet size. For instance, the modulating nozzle assembly 110 includes at least one orifice plate 307 coupled with an actuator, and the actuator moves the at least one orifice plate 307 into or out of the flow of the agricultural product by controlling the orifice upstream of the spray tip 304, for instance according to control instructions from the spray modulation interface of the nozzle assembly controller 122. In a similar manner to the control valve 302 operated as the pre-orifice, operation of the one or more orifice plates 307 to close the upstream orifice causes an increased pressure drop across the one or more orifice plates 307 and increases droplet size emanating from the spray tip 304. Conversely, opening of the orifice through opening movement of the one or more orifice plates 307 decreases the pressure drop across the plates 307 and decreases droplet size emanated.

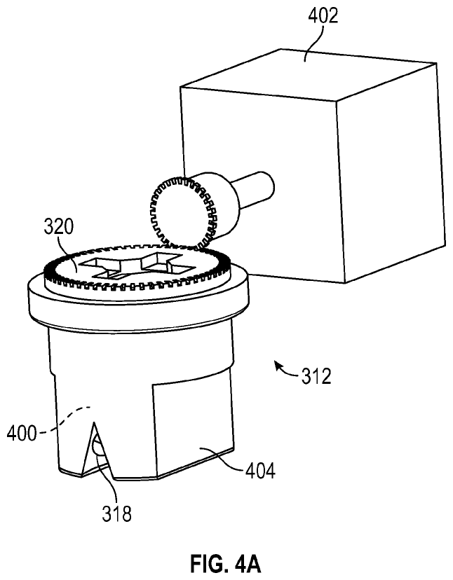

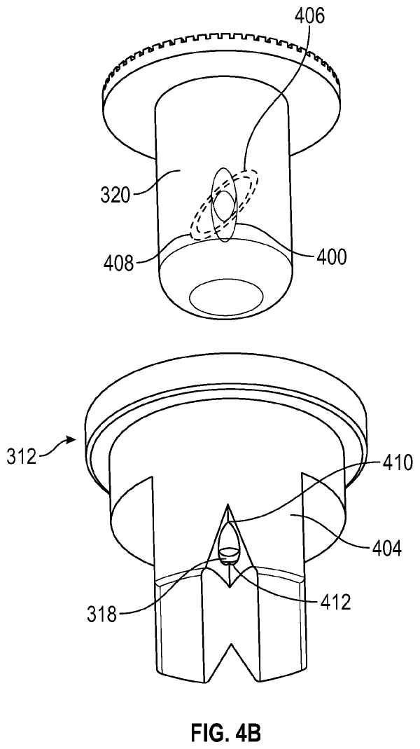

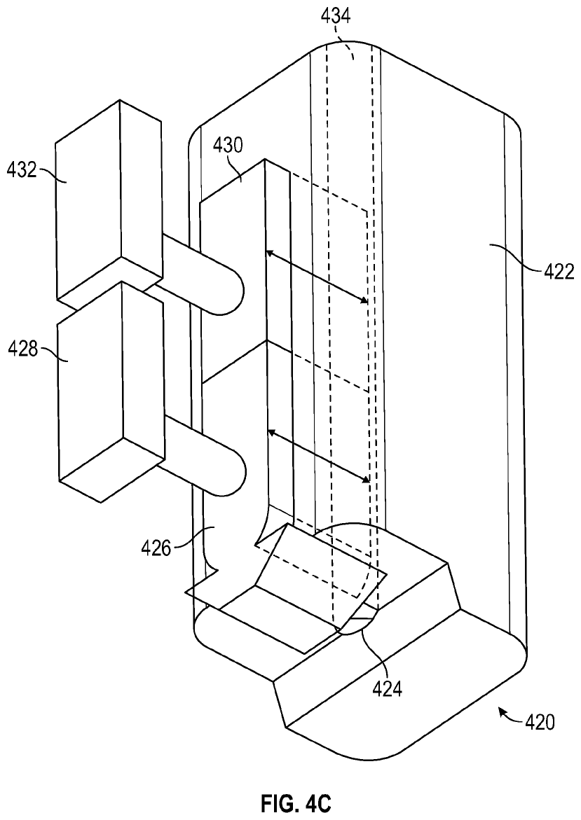

Other examples modulating spray actuators include, but are not limited to, a modulating spray tip 312, a modulating accumulator 314, gas inductor 316 in addition to or alternative to the control valve 302. As shown in FIGS. 3A, 3B the modulating nozzle assembly 110 in this example includes the modulating spray tip 312 as the spray tip 304. The modulating spray tip 312 includes one or more spray ports 318 and a nozzle fitting 320 having one or more fitting ports. The spray ports 318 and the fitting ports (see FIG. 4B) of the nozzle fitting 320 are actuated in combination (e.g., translated or rotated relative to each other) to selectively align and misalign to vary a composite spray orifice including the respective spray port 318 and fitting port of the nozzle fitting 320. Misalignment of the ports contracts the composite spray orifice and accordingly provides a finer spray having corresponding smaller droplet sizes. Conversely, alignment of the ports enlarges the composite spray orifice and provides a coarse spray having corresponding larger droplet sizes. Examples of droplet sizes include one or both of quantitative sizes (e.g., specified dimensions, dimension ranges) or qualitative sizes including ultrafine, fine, medium, coarse, ultracoarse or the like. In other examples, the relative movement of the nozzle fitting and its fitting ports relative to the one or more spray ports 318 changes the spray pattern, such as the arc of the spray pattern coverage, in combination with or independently from control of droplet size.

The gas inductor 316 is another example of a modulating spray actuator of the modulating nozzle assembly 110. In the example shown in FIG. 3A, the gas inductor includes one or more induction valves 322 interposed between a gas source 324 and the remainder of the nozzle assembly 110. The gas inductor 316 is interposed between the spray tip 304 and the control valve 302. The gas source 324 includes ambient atmosphere, a reservoir of gas (e.g., Nitrogen, compressed air or the like).

The induction valves 322 include valves configured to control a flow rate of gas to the agricultural product prior to application. In an example, the induction valves 322 include needle valves and associated actuators that move the valve needles between seated and unseated configurations to meter the introduction of gas to the agricultural product.

In operation, the induction valves 322 are controlled to increase, decrease or maintain a flow rate of gas to the agricultural product. An increased flow rate of gas to the agricultural product increases droplet size in the sprayed agricultural product (e.g., the droplets are coarser). Conversely, a decreased flow rate of gas to the agricultural product decreases droplet size and provides a finer sprayed agricultural product. Optionally a gas quality sensor, humidity sensor or composition sensor is included with the gas inductor to assess the input gas (e.g., atmosphere) prior to or during induction.

The modulating nozzle assembly 110 shown in FIGS. 3A, B includes a modulating accumulator 314 as another example spray modulating actuator. As shown, the modulating accumulator includes an assembly chamber 326 interposed between the control valve 302 and the spray tip 304 to facilitate mixing of gas with the agricultural product (e.g., with an expanded volume of the accumulator) to increase droplet size (make coarser). Alternatively, the assembly chamber 326 is contracted with the accumulator 314 to decrease droplet size (e.g., make fine droplets with a contracted volume).

In the example shown in FIG. 3A, the modulating accumulator 314 includes a telescoping accumulator body 328 operated with an associated accumulator actuator (e.g., motor) to vary the volume of the accumulator/assembly chamber.

As further shown in FIG. 3A, the modulating nozzle assembly 110 provides one or more spray patterns 330 emanating from the spray tip 304 (optionally the modulating spray tip 312). The spray pattern 330 includes a characteristic such as an arc, shape or the like, for instance corresponding to the arc of the spray from each spray port 318, the combined arc between spray ports 318 of the assembly 110 or the like. Additionally, the spray pattern 330 includes droplets therein having a droplet size corresponding to a qualitative dimension (fine, coarse or the like) or a quantitative dimension (e.g., microns, millimeters or the like). The spray pattern 330 and the associated droplets therein are examples of an actual spray profile generated from the modulating nozzle assembly 110. As described herein, the actual spray profile is controlled with the spray modulating actuators to achieve one or more specified spray profiles, for instance based on observations of the actual spray profile and deviation of the actual spray profile relative to a specified spray profile.

FIGS. 4A and 4B are examples of a modulating spray tip 312. The modulating spray tip 312, as described herein, is one example of a spray modulation actuator configured to control one or more features of the spray pattern including, for instance, droplet size, spray pattern profile (e.g., coverage, arc or shape of the pattern) or the like. As shown in FIG. 4A, the modulating spray tip 312 is shown in an assembled configuration. The modulating spray tip 312 includes a spray tip housing 404 and a nozzle fitting 320 movably coupled with the housing 404. The spray tip housing 404 includes one or more spray ports 318, and the nozzle fitting 320 conversely includes one or more corresponding fitting ports 400. Alignment and misalignment (referred to as varied or modulating alignment) of the spray ports 318 and fitting ports 400 controls one or more features of the actual spray profile emanated from the spray tip 312. For instance, varied alignment controls one or more of droplet size or spray pattern (e.g., coverage, arc or shape of the spray pattern).

FIG. 4B shows an exploded view of the modulating spray tip 312 previously shown in FIG. 4A. In this example, the nozzle fitting 320 is shown decoupled from the spray tip housing 404. As previously described, the modulating spray tip through 312 includes one or more spray ports 318 provided with the spray tip housing 404 while the nozzle fitting 320 includes one or more fitting ports 400. Movement of the nozzle fitting 320, for instance by rotation, changes the alignment between the fitting ports 400 with the spray ports 318 and thereby changes a profile composite spray orifice of the of spray tip 312. A nozzle fitting actuator 402 is shown in FIG. 4A, and is operatively coupled with the nozzle fitting 320. For instance, the nozzle fitting 320 includes a rack contoured surface and the nozzle fitting actuator 402 includes a pinion configured to interfit with the rack of the nozzle fitting. Rotation of the nozzle fitting actuator 402 having the pinion correspondingly rotates the nozzle fitting 320 relative to the spray tip housing 404 and thereby changes the position of the fitting ports 400 relative to the spray ports 318.

As further shown in FIG. 4B, in one example the fitting ports 400 include a slanted ovular configuration as shown with dashed lines. Alignment of the slanted fitting ports 400 with the spray ports 318 controls droplet size. In another example, the slanted configuration also permits control of the spray pattern itself, for instance the arc, coverage or pattern profile as described herein. Alignment of the upper portion 406 of with dashed fitting ports 400 with the spray ports 318 directs the agricultural product flow through the fitting ports 318 and into the relatively narrow or tapered upper portion 410 of the spray ports 318 that is directed relatively downward. The agricultural product is thereby directed downward in a relatively narrow arc. Conversely, rotation of the nozzle fitting 320 to align the middle or lower portion 408 of the fitting ports 400 with the lower portion 412 of the spray ports 318 permits the direction of agricultural product laterally through each of the fitting ports and spray ports with minimized interruption by the upper portion of the spray ports 318. The spray pattern with this alignment is correspondingly wider and has a greater arc for increased breadth of coverage. Varying the position of the nozzle fitting 320 changes the alignment of the upper and lower portions 406, 408 relative to the spray ports 318 and accordingly provides a range of spray profiles from narrow (e.g., directed vertically down) to wide (e.g., directed down and at angles to the sides, as a fan) and intermediate profiles therebetween.

FIG. 4C is another example of a modulating spray tip 420 including consolidated functionality of an orifice in a similar manner to the modulating spray tip 312 shown in FIGS. 3A and 4A, B. In this example, the modulating spray tip 420 includes multiple spray modulation actuators, for instance, a nozzle fitting 426 that provides a modulating orifice similar in some regards to the modulating spray tip 312 shown in FIGS. 4A, B and at least one modulating orifice plate 430 similar to the orifice plates 307 as a pre-orifice shown in FIG. 3A. The nozzle fitting 426 provides a modulating orifice, while the at least one modulating orifice plate 430 provides a modulating pre-orifice.

The nozzle fitting 426 of the modulating spray tip 420 is movably coupled with the spray tip housing 422. In the example shown in FIG. 4C the nozzle fitting 426 translates as shown with the directional arrows. For instance, a nozzle fitting actuator 428 (e.g., an orifice actuator) is coupled with the nozzle fitting 426. The nozzle fitting actuator 428 includes, but is not limited to, a stepper motor having a screw drive interconnecting the actuator and the nozzle fitting 426. The nozzle fitting actuator 428 implements control instructions, for instance received from the nozzle assembly controller 122, to position the nozzle fitting 426 relative to one or more of a passage 434 through the spray tip housing 422, the spray port 424 or both (e.g., including all or a subset of closed, open, and intermediate positions). Positioning the nozzle fitting 426 changes the profile of the spray port 424, such as the spray port size, shape, combinations of both or the like. For instance, with inward movement of the nozzle fitting 426, the profile of the spray port 424 is decreased, and the droplet size emanating from the spray port 424 is decreased (e.g., becomes finer). Conversely, movement of the nozzle fitting 426 toward the exterior increases the spray port 424 profile, and the droplet size emanated is increased (e.g., becomes coarser).

The one or more orifice plates 430 of the modulating spray tip 420 are positioned upstream of the spray port 424 as previously shown in FIG. 3A. As shown in FIG. 4C, the orifice plate actuator 432 (e.g., a pre-orifice actuator) is coupled with the orifice plate 430. In a similar manner to the nozzle fitting actuator 428 the orifice plate actuator 432 optionally includes a stepper motor having a screw drive to interconnect with the orifice plate 430. The orifice plate actuator 432 implements control instructions to position the orifice plate 430 relative to the passage 434 extending through the spray tip housing 422 including, each or a subset of, closed (e.g., fully closed to prevent flow), open and intermediate positions. Positioning of the orifice plate 430 changes the profile of the passage 434 within the spray tip housing 422 upstream of the spray port 424 (e.g., in the manner of a pre-orifice). For example, inward movement of the orifice plate 430 (shown with directional arrows in FIG. 4C) increases the pressure drop across the orifice plate 430 and increases the droplet size emanating from the spray port 424. Conversely, movement of the orifice plate to expand the passage decreases the pressure drop across the orifice plate, and correspondingly maintains a higher pressure to the spray port 424 and decreases the droplet size emanating from the port 424. In this example, the arrangement of the pre-orifice (the orifice plate 430) proximate to the spray port 424 replaces the valve operator 306 as a pre-orifice spray modulation actuator, and thereby leaves the control valve 302 and operator 306 (FIG. 3A) to control flow rate to the spray port 424. In another example, the control valve and its valve operator 306 are operated as another pre-orifice with the orifice plate 430 shown in FIG. 4C to provide enhanced modulating of the actual spray profile including multiple pre-orifice control of droplet size.

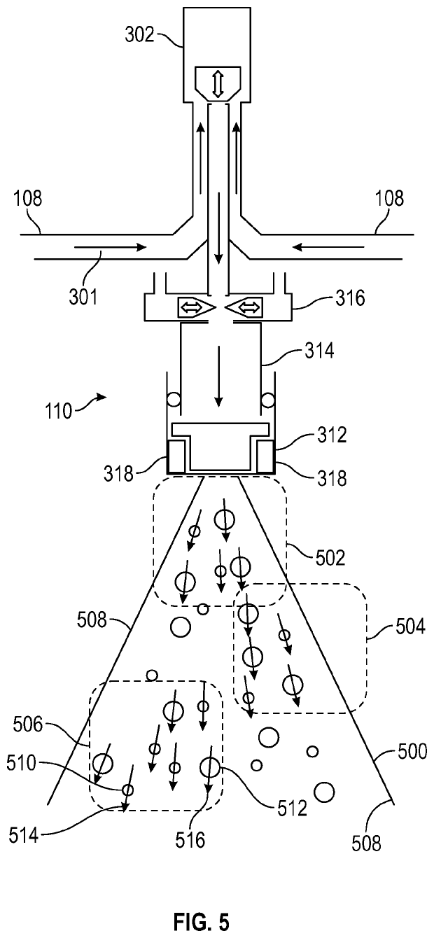

FIG. 5 is a schematic view of the modulating nozzle assembly 110. The assembly 110 includes multiple example spray modulation actuators previously described and shown with FIGS. 3A, B. In the example shown in FIG. 5, one schematic example of a specified spray profile 500 is shown relative to the modulating nozzle assembly 110. The specified spray profile 500 is shown with one or more specified spray characteristics including, but not limited to, spray droplet size (including a range of droplet sizes), droplet kinematics and spray pattern. The specified spray profile 500 is also shown with a plurality of monitoring sections 502, 504, 506. The monitoring sections 502, 504, 506 facilitate efficient viewing of zones or regions of a spray profile to minimize processing capability otherwise needed for observation and analysis of the entire profile or a large portion of the spray profile. Instead, a spray sensor (like the spray sensor 124 in FIG. 1) observes the spray profile, captures video, images or the like, and analysis is conducted at one or more locations of interest within the video or images. For instance, in the view shown in FIG. 5, locations of interest include section 502 proximate the modulating spray tip 312, where a spray pattern is initially generated. Additional example locations of interest are shown with section 504 and 506. Section 504 is proximate a pattern edge 508 (right) of the spray pattern, and second section 506 is proximate the opposed edge 508 (left) of the spray pattern. Accordingly, characteristics of droplets near to the pattern edges (where spray drift may be most pronounced) are determined. In another example, one or more sections, like section 506, are proximate to a target, such as crops, pests, weeds, ground or the like. Section 506 permits observation and analysis of droplets proximate to these targets, including as shown herein, deflection of spray droplets from targets.

Referring again to FIG. 5, the specified spray profile 500 is one example of a spray profile used as a threshold or basis for comparison with actual spray profiles, for instance to facilitate automatic control of the modulating nozzle assembly 110 that guides performance of the assembly to generate an actual spray profile that approximates (e.g., matches, approaches or the like) the specified spray profile 500. The specified spray profile 500 includes one or more spray characteristics that are thresholds for comparison against the corresponding actual spray characteristics of an actual spray profile, for instance observed with the spray sensors 124 and analyzed within the sections 502, 504, 506 as noted herein.

In the example shown in FIG. 5, the specified spray profile 500 includes one or more component spray characteristics including, but not limited to droplet size, droplet kinematics and spray pattern. The droplet size characteristic includes a specified droplet size (dimension, profile identifier, such as coarse, fine or the like; array of sizes; ratio of sizes large:small, coarse:fine, ultracoarse:coarse:fine:extremely fine)) or the like. In other examples, the droplet size characteristics includes a distribution of droplet sizes, such as a geometric, normal, exponential, Poisson distribution or the like. The droplet size characteristic is an example threshold for comparison against the actual spray profile. In the example shown in FIG. 5, the droplets 510, 512 are different sizes, and each is included with the specified spray profile 500. Accordingly, the specified spray profile 500 includes at least two permitted droplet sizes, and in other examples, the spray profile 500 permits a range of droplet sizes including the sizes shown with the droplets 510, 512 (e.g., as permitted outliers; first quartile and fourth quartile sizes, or the like). In still another example, the spray droplets 510, 512 are indicative of a specified distribution or range of droplet sizes with the spray droplet 510 the median value for size, the spray droplet 512 one standard deviation of size to the right of the spray droplet 510, and the remainder of the distribution populated according to the type of distribution used (e.g., normal, Poisson, or the like). Droplet size characteristics are provided to facilitate comparison with corresponding size characteristics of actual spray profiles and thereby determine one or more spray profile deviations between the specified spray profile 500 and the actual spray profile for use as inputs to the modulating nozzle assembly 110.

The specified spray profile 500 droplet kinematics 514, 516 are additional examples of spray characteristics optionally included with the profile 500 as thresholds for comparison with an actual spray profile. In the example shown in FIG. 5, the droplet kinematics 514, 516 included, but are not limited to, one or more of position, direction, speed, acceleration or the like. As shown, the kinematics are indicated with example vector arrows with the origin of an arrow corresponding to a droplet position, the direction and magnitude of the vector corresponding direction of movement and speed, respectively, while other characteristics like acceleration are input or determined mathematically from other kinematic characteristics (e.g., velocity). In a similar manner to the droplet sizes, droplet kinematics are optionally provided as one or more values, ranges, distributions or the like to facilitate comparison with corresponding characteristics of actual spray profiles and thereby determine one or more spray profile deviations between the specified spray profile 500 and the actual spray profile for use as inputs to the modulating nozzle assembly 110.

As further shown in FIG. 5, the specified spray profile 500 includes a spray pattern as another example of a spray characteristic. The spray pattern is illustrated with the pattern edges 508. The pattern edges 508 are indicative of specified boundaries of the specified spray profile 500. The pattern edges 508 are shown as lines in FIG. 5. The actual spray profile 500, in some examples, includes the pattern edges 508 as arc or degree values measured from vertical or another reference, a width dimension of the spray profile a specified distance from the modulating spray tip 312 or the like. The spray pattern, such as the pattern edges 508 is provided to facilitate comparison with the pattern of the actual spray profile and determine whether the actual spray profile is wide, narrow or angled relative to the specified spray profile 500. Spray profile deviations between the specified spray profile 500 (e.g., the spray pattern) and the actual spray profile spray pattern are use as inputs to the modulating nozzle assembly 110, as described herein. In the example shown, two or more spray ports 318 provide a combined arc of approximately 40 degrees. The specified spray pattern varies in some examples based on boom height, with tighter (smaller) arcs used at greater boom heights and wider (larger) arcs used at lesser boom heights to ensure coverage of targets (plants, crops, weeds, ground or the like).

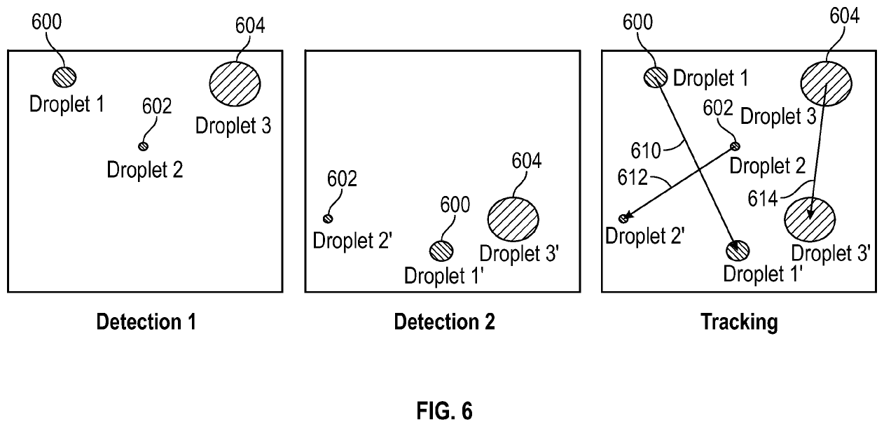

FIG. 6 is a series of proximate views of an actual spray profile, for instance corresponding to a section of observation with a spray sensor 124 designated for analysis. The proximate views (e.g., Detection 1, 2, and so on) are images from the section that include a plurality of droplets 600, 602, 604 shown at example times (e.g., t1, t2 and a composite Tracking view). FIG. 6 is a graphical example illustrating identification and tracking of droplets, for instance to facilitate the determination of spray characteristics of an actual spray profile for comparison against the specified spray profile and its associated spray characteristics. The graphical example is shown in two dimensions for ease of illustration. In practice the spray pattern (and associated droplets 600, 602, 604) is in some examples at an angle to the spray sensor, the spray pattern is at an angle to the travel direction of the vehicle (and accordingly the sensor) to provide overlap of spray patterns without collision of droplets, or the spray pattern includes at least some droplets moving transverse to a plane of a spray pattern (e.g., because of wind). Accordingly, each of the position, velocity, acceleration or the like of the droplets 600, 602, 604 may have three components, including x, y, and z components, to permit identification and tracking in three dimensions as well as determine one or more kinematic values of the droplets such as position, velocity or acceleration. Correspondingly, the spray sensor 124 is configured in various examples to permit identification and tracking in three dimensions (e.g., with a stereo camera, multiple camera system, radar, LIDAR, ultrasound sensors or the like that permit three dimensional identification and tracking).

The Detection 1 and Detection 2 views are example views from a monitored section observed with the spray sensor 124 and include example droplets 600, 602, 604 that are assessed to identify the droplets between successive views (e.g., frames of video, still images or the like corresponding to Detection 1 and Detection 2). For instance in FIG. 6 the plurality of droplets 600, 602, 604 are shown in Detection 1 and Detection 2. Droplet 1 and Droplet 1′ have similar droplet sizes, and in one example Droplet 1′ follows a predicted vector for Droplet 1. Conversely, Droplets 2 and 2′ and Droplets 3 and 3′ similarly have like droplet sizes and may follow predicted vectors for each of the droplets.

The nozzle assembly controller 122 includes an identification module (as shown in FIG. 1) that assesses the droplets 600, 602, 604 (and likely other droplets within the observed section) and applies an algorithm with predicted vectors, position or behavior for droplets to facilitate identification of the droplets 600, 602, 604 between images such as Detections 1 and 2 (and in some examples repeats the process for a plurality of droplets in this section observed with the spray sensor 124). For example, the identification module identifies Droplet 1′ in Detection 2 as corresponding to Droplet 1 in Detection 2 and Droplet 1 and 1′ based on conformity of predicted behavior of the droplet (vector, position or the like), droplet size similarity or the like. Droplet 1 and 1′ is thereafter identified as droplet 600. In a similar manner, Droplet 2 and Droplet 2′ are identified as droplet 602 because of one or more of similarity of droplet size, conformance with predicted behavior in each of Droplet 2 and 2′. Droplets 2 and 2′ are thereafter identified as droplet 602. Droplets 3 and 3′ are similarly identified as droplet 604.

The identification of droplets 600, 602, 604 with the identification module permits tracking of the droplets 600, 602, 604, for instance with the tracking module of the nozzle assembly controller 122. An example of tracking of the droplets is shown in the Tracking view of FIG. 6. The Tracking view is a superimposed image with the droplets 600, 602, 604 identified and tracked between Detection 1 and Detection 2. Vectors 610, 612, 614 are drawn between the droplets 600, 602, 604 from their positions in Detection 1 and Detection 2.

The vector magnitude corresponds to a distance travelled while the vector direction corresponds to the direction of travel for each of the droplets 600, 602, 604. As discussed herein, the positions of the droplets 600, 602, 604 and their associated vectors 610, 612, 614 may have three dimensions and corresponding three dimensional components. Additionally, the distance travelled (vector length) and time span between Detection 1 and Detection 2 is used to determine the speed of each of the droplets (or velocity vector). Other kinematics, such as acceleration, are determined mathematically including through analysis of velocities, positions or the like. In one example, a droplet is tracked across three or more frames (e.g., monitoring sections, images in timed series or the like) and acceleration is determined from the frames, such as the changing droplet position. The tracking module of the nozzle assembly controller 122 thereby tracks the identified droplets 600, 602, 604 and the associated kinematics of each of the droplets are determined and provided for analysis. For instance, the comparator of the nozzle assembly controller 122 compares one or more of the identified droplet sizes, droplet kinematics or the like with corresponding characteristics of the specified spray profile 500 shown in FIG. 5.

As discussed above, the identification and tracking of droplets are optionally conducted as separate steps, with identification preceding tracking. In another example, the nozzle assembly controller 122 consolidates or partially consolidates identification with tracking of droplets. For example, as noted above, predicted behavior of the Droplets 1, 2 and 3 is analyzed for the Droplets 1′, 2′ and 3′. In some examples, the predicted behavior includes analysis of one or more potential vectors of Droplet 1 to Droplet 1′, 2′ and 3′ (candidate droplets), and selection of Droplet 1′ as the highest probability match to Droplet 1 because of conformity to a predicted vector thereby identifying Droplet 1 and 1′ as droplet 600. The analysis of vectors for identification of droplet 600 is, in one example, also used for tracking of the droplet 600. For instance, the initial determined vector for identification of the droplet 600 provides an initial set of kinematics for the droplet to compare against the specified spray profile 500 and the associated characteristics of the specified spray profile.

Optionally, the identification module continues to identify the droplet 600 in forthcoming images (Detection 3, 4 and so on) with determined velocity vectors extended toward candidate droplets in later images, and thereby provides kinematics for comparison by the controller 122 comparator. In this manner, the identification module and tracking module are potentially consolidated. In other examples, once identified, the tracking module assumes the tracking function and continues to determine updated vectors for each of the identified droplets 600, 602, 604.

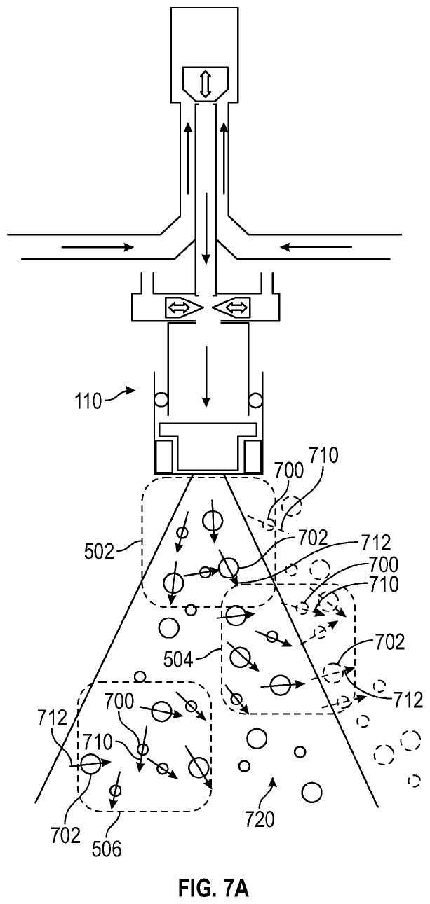

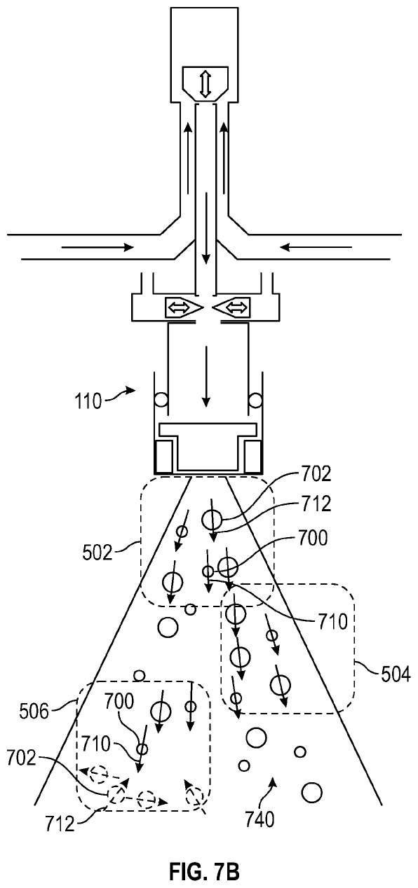

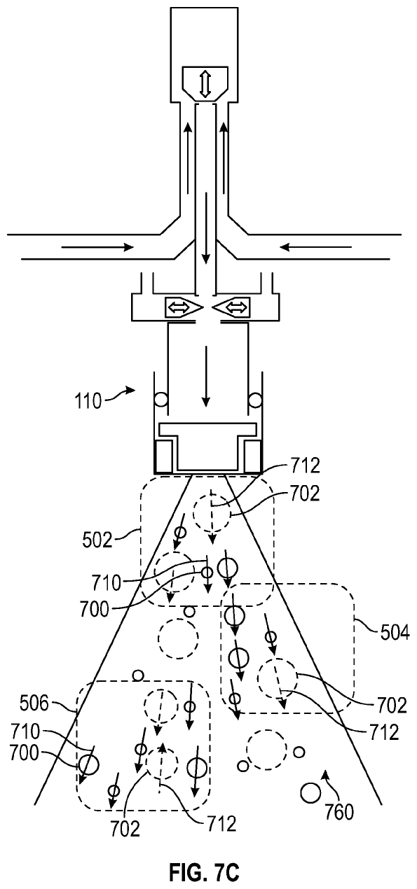

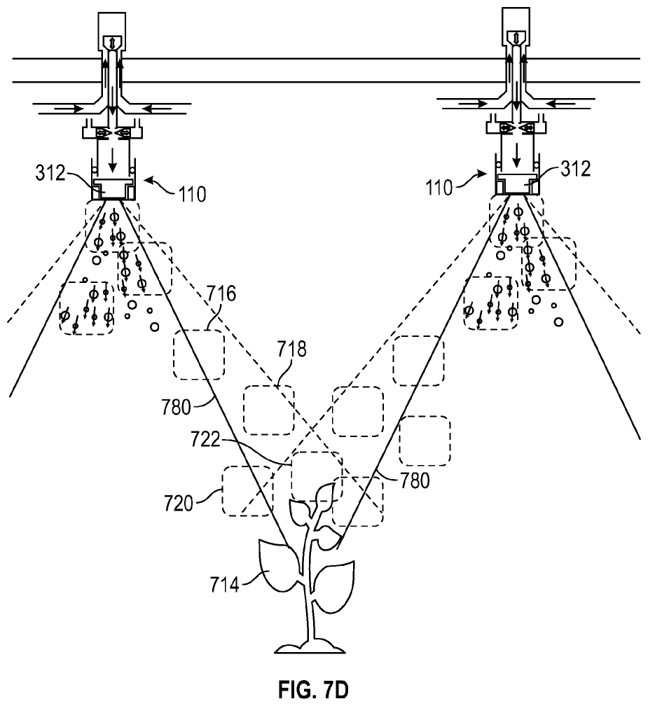

7A-7D are examples of spray profile deviations of actual spray profiles 720, 740, 760, 780 relative to a specified spray profile, such as the profile 500 shown in FIG. 5. Furring first to FIG. 7A, an example of the modulating nozzle assembly 110 is shown with an actual spray profile 720 representative of a profile subject to spray drift caused by wind perturbations. As shown, one or more of the droplets 700, 702 are beyond the specified spray pattern (shown with angled lines in FIG. 7A and corresponding to the pattern edges 508 of the specified spray profile 500).

As shown in FIG. 7A the actual spray profile 720 includes one or more monitoring sections 502, 504, 506 superimposed on the actual spray profile 720. The monitoring sections include, one or more of a first monitoring section 502 proximate to the modulating nozzle assembly 110, a second monitoring section 504 proximate to a first side of the actual spray profile 720, and a third monitoring section 506 proximate to an opposed side of the actual spray profile 720. As shown, each of the monitoring sections 502 include droplets 700, 702 and associated droplet kinematics 710, 712.

In the example shown in FIG. 7A the first and second monitoring sections 502, 504 include one or more droplets 700, 702 that deviate from the specified spray profile 500. For instance as shown in FIG. 7A droplet positions of one or more of the droplets 700, 702 in each of the monitoring sections 502, 504 are outside of the specified spray profile 500 including the pattern edges 508 shown in FIG. 5. Additionally, droplets 700, 702 at least in the first and second monitoring sections 502, 504 as well as the third monitoring section 506 include one or more droplet kinematics 710, 712 (e.g., vectors in this example) that are skewed relative to the droplet kinematics 514, 516 shown in the specified spray profile 500. In contrast, the droplet sizes of the droplets 700, 702 comport with the droplet sizes of the spray droplets 510, 512 shown in the specified spray profile 500 thereby indicating that the droplets 700, 702 conform to the specified spray profile 500.

Accordingly, deviations of the actual spray profile 720 relative to the specified spray profile 500 are determined, for instance with the comparator of the nozzle assembly controller 122. As discussed herein, the deviations are in some examples plural. For instance, as noted in the discussion of FIG. 7A, the deviations in the spray drift example relative to the specified spray profile include both position (kinematic) based deviations of the droplets 700, 702 as well as vector (kinematic) based deviations of the droplets. As discussed herein, in one example the nozzle assembly controller 122 including the comparator and the spray modulation interface conducts one or more active control steps with one or more of the spray modulation actuators associated with the modulating nozzle assemblies experiencing the deviations to address and minimize those deviations (e.g., including decreasing or eliminating). For instance, the comparator and spray modulation interface cooperate in one example to increase droplet size of the actual spray profile 720 and minimize the effect of wind perturbations that otherwise cause spray drift (one or more of position and vector deviations) of the actual spray profile 720 relative to the specified spray profile 500.

FIG. 7B shows another example of an actual spray profile 740. In this example the actual spray profile 740 is representative of one example of droplet deflection, for instance relative to a target such as a crop canopy, leaves or the like of crops or weeds. As shown in FIG. 7B the modulating nozzle assembly 110 is shown again with the actual spray profile 740 emanating therefrom.

As shown in FIG. 7B the actual spray profile 740 one or more monitoring sections, such as the monitoring section 502, 504, 506. Each of the monitoring sections 502, 504, 506 includes a plurality of droplets 700, 702 having associated droplet kinematics 710, 712 (e.g., position, velocity, acceleration or the like). In each of the first and second monitoring sections 502, 504 the droplets 700, 702 and their associated kinematics 710, 712 comply with the specified spray profile 500 shown in FIG. 5. For instance the droplet sizes and their vectors (kinematics) of the droplets 700, 702 comply with the characteristics of the specified spray profile, such as the droplet sizes and kinematics (e.g., 510, 512 and 514, 516). Additionally, the droplet 700, 702 positions are within the specified spray profile 500 (e.g., shown with the pattern edges 508 in FIG. 5).

In contrast, the droplets 700, 702 in the monitoring section 506 proximate to a target, such as a crop, leaves of the crop, leaves of a weed or the like, include droplets 702 (the larger droplets) having associated droplet kinematics 712. As shown in FIG. 7B the droplets 702 include kinematics 712 directed in a variety of skewed directions relative to the otherwise consistently vertical kinematics 710, 712 of the other droplets 702, 700. With regard to the specified spray profile 500, the droplet kinematics 712 are skewed relative to the kinematics 514, 516 shown in FIG. 5. Additionally, as further shown in FIG. 7B be the droplets 702 having the larger relative size to the droplets 700 are shown with droplet kinematics 712 that deviate relative to the specified spray profile 500 (e.g., kinematics 514, 516) while the smaller droplets 700 have droplet kinematic 710 that comply with the specified spray profile 500. This variation of kinematics for the larger droplets 702 in comparison to the smaller droplets 700 indicates in one example that the larger droplets 702 are subject to deflection after contact with one or more features such as the target canopy, leaves or the like. With regard to the remainder of the actual spray profile 740 it appears the droplets 700, 702 comply with the specified spray profile 500 including for instance the example sizes of the droplet 510, 512.

The deviations determined through comparison of the actual spray profile 740 to the specified spray profile 500 with the comparator of the nozzle assembly controller 122 are addressed with actuation instructions from the spray modulation interface of the controller 122 to the associated modulating nozzle assemblies 110. In one example the actuation instructions include one or more instructions to spray modulation actuators associated with the modulating nozzle assemblies 110 to decrease droplet sizes, and generate an actual spray profile with smaller droplets that more readily adhere to the target (crop or weed) without deflection. Accordingly, the actual spray profile 740 changes to have smaller droplet sizes and better complies with the specified spray profile 500 (e.g., decreases deviation, such as the deflection associated with skewed kinematics).

FIG. 7C is another example of an actual spray profile 760 that varies relative to the specified spray profile, such as the profile 500 shown in FIG. 5. In this example the modulating spray assembly 110 is shown again with the actual spray profile 760 emanating therefrom. Monitoring sections such as the monitoring sections 502, 504, 506 are overlaid on the actual spray profile 760. In this example droplets 700 and associated droplet kinematics 710 are shown for each of the sections 502, 504, 506. Additionally droplets 702 including droplet kinematics 712 are shown for the monitoring section 502, 504, 506. The droplets 702 deviate from the specified spray profile 500 for instance because of the relatively large droplet size of the droplets 702 in comparison to the droplets 510, 512 shown with the specified spray profile 500 (e.g., a droplet size range). The deviation of the droplet 702 size in the monitoring section 506 (proximate to a target) may also precipitate one or more kinematic deviations shown with droplet kinematics 712. For instance as previously described herein and shown in FIG. 7B larger droplets in one example may cause deflection of the larger droplets 702. As shown in the monitoring section in FIG. 7C the droplet kinematics 712 of the larger droplets indicate deflection of the droplet 702 because of the skewed orientation of the droplet kinematics relative to the specified kinematics 514, 516 of the specified spray profile 500.

In operation, the comparator of the nozzle assembly controller 122 identifies the deviation of the droplet 702 size and the droplet kinematic 712 (at least in the monitoring section 506) relative to the specified spray profile 500. For instance the droplet 702 and its associated droplet kinematics 712 are analyzed with the comparator relative to the specified spray profile to determine one or more spray profile deviations. The nozzle assembly controller 122 provides one or more instructions through spray modulation interface spray modulation actuators associated with the modulating nozzle assembly 110 to accordingly decrease droplet size and thereby better comply with the specified spray profile 500. For instance the droplets 702 shown in the actual spray profile 760 are in one example decreased in size with the spray modulation actuator (or actuators) to more closely approximate the droplet size associated with the specified spray profile 500 and thereby decrease the previously determined spray profile deviation.

FIG. 7D is another example of a modulating nozzle assembly 110 (two assemblies are shown in FIG. 7D) with actual spray profiles 780 deviating relative to a specified spray profile in this example including a target coverage characteristic. As shown the actual spray profiles 780 of each of the modulating nozzle assemblies 110 is directed toward a target 714. The target includes, but is not limited to, a crop, weed, pest, portion of a target such as the canopy, leaves, foliage or the like.

As further shown in FIG. 7D in this example a plurality of monitoring sections are 716, 718, 720, 722 are proximate to the actual spray profiles 780. As shown, at least some of the monitoring section 716, 718, 720, 722 are outside or partially outside of the actual spray profile 780, for instance to observe a pattern edge of the actual spray profile 780, observe coverage of the actual spray profile 780 relative to the target 714 or the like. In this example, target coverage is a characteristic included with the specified spray profile, such as then specified spray profile 500 previously shown in FIG. 5. The target coverage includes a threshold corresponding to inclusion of the target within the spray pattern. For instance, the target coverage includes values corresponding to full coverage (of plant height or foliage), partial coverage (some percentage of the plant height or foliage) or the like.

The actual spray profiles 780 of each of the modulating nozzle assemblies 110 fail to cover the target 714 as shown in FIG. 7D. In an example the specified spray profile 500 includes full target coverage as the target coverage characteristic. Full target coverage is satisfied in one example with encompassing of the target 714 within the actual spray profile 780. Conversely, spray profile deviation is determined for less than full encompassing of the target 714 in the actual spray profile 780 as is the case in FIG. 7D. For example as shown in FIG. 7D, the spray pattern of the actual spray profile 780 (shown in solid lines) extends to a portion of the target 714 while missing the upper foliage of the target 714. The second modulating nozzle assembly 110 including the left edge shown in FIG. 7D similarly fails to encompass the upper foliage of the target 714.

The nozzle assembly controller 122, as described herein, identifies droplets of the actual spray profile 780 and tracks the droplets. The identification and tracking establishes the pattern edge (the solid line) of each of the actual spray profiles 780. Because the monitoring sections 716, 718, 720, 722 or the like observe both the actual spray profile 780 and the target 714 the spray profile 780 is observed relative to the target 714 and a comparison (e.g., with the comparator of the controller 122) is conducted between the actual spray profile 780 actual coverage and the target coverage of the specified spray profile 500 to determine the spray profile deviation coverage deviation (e.g., between the specified spray profile and the actual spray profile).

The nozzle assembly controller 122 generates one or more control signals with the spray modulation interface for one or more spray modulation actuators of the modulating nozzle assemblies 110. The control signals actuate the one or more spray modulation actuators, such as modulating spray tips 312, to widen the actual spray profile 780 and thereby increase coverage of the target 714. Conversely, coverage deviation, as an example of spray profile deviation, is minimized (e.g., decreased or eliminated). In the example shown in FIG. 7D the expanded coverage corresponds to the dashed lines extending to the upper foliage of the target 714.

In another example, the nozzle assembly controller 122 is in communication with other systems of the agricultural vehicle, such as the sprayer 100. For instance, the nozzle assembly controller 122 is in communication with boom height actuators, suspension systems or the like. These actuators include one or more motors, hydraulic cylinders or the like to control the sprayer boom 106 position, see FIG. 1. Optionally, the nozzle assembly controller 122 adjusts sprayer boom 106 height based on the deviation in target coverage observed and determined as discussed above. For instance, the sprayer boom 106 is automatically raised by the nozzle assembly controller 122 until the actual spray profile 780 encompasses the upper foliage of the target 714 and thereby satisfies the specified spray profile having a target coverage threshold including full coverage. In this manner, variations in terrain, target height or the like are detected with the nozzle assembly controller 122 and the spray sensor 124 through comparison of actual target coverage of the spray pattern for the target 714 in comparison to the specified target coverage (e.g., of the specified spray profile 500). These variations are interpreted as target coverage deviations that are readily addressed through one or more target coverage control with the modulating spray tips 312, boom height adjustment, suspension height adjustment or the like. In other examples, the nozzle assembly controller 122 conducts one or both types of actuation in cooperation, such as boom height control, suspension height control, or actuation of modulating spray tips 312 (or other spray modulation actuators).

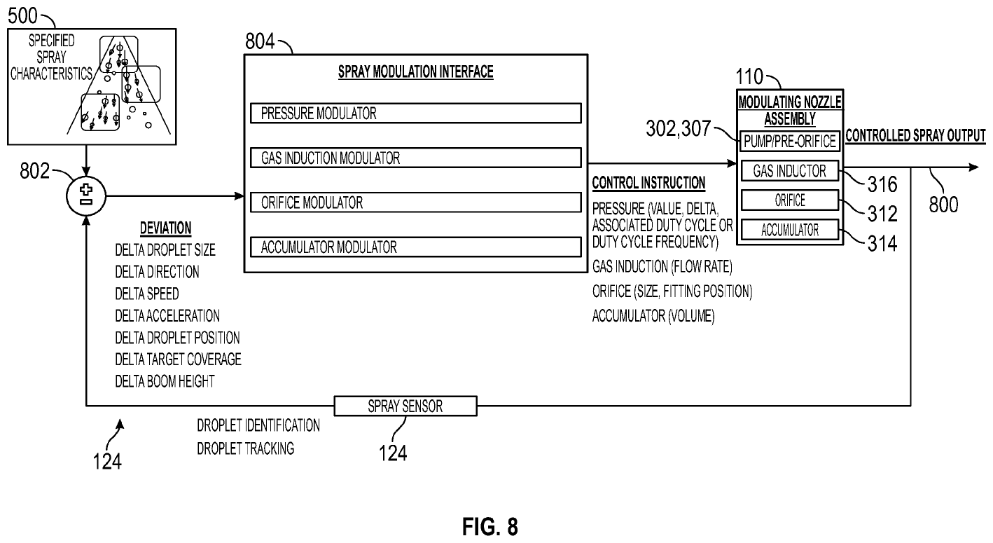

FIG. 8 is a schematic view of one example of the sprayer nozzle assembly control system 120. The sprayer nozzle assembly control system 120 including the nozzle assembly controller 122 previously shown in FIG. 1. One or more of the components of the controller 122 are shown in FIG. 8 or are included in the components shown in FIG. 8.

As shown in FIG. 8, the sprayer nozzle assembly control system 120 as includes at least one specified spray profile 500 an input to the system 120. The specified spray profile includes one or more droplet characteristics (e.g., droplet size, kinematics or the like), spray pattern characteristics (e.g., width, arc, target coverage) or the like for comparison with corresponding characteristics of a monitored actual spray profile 800. A comparator 802 of the nozzle assembly controller 122 compares the specified spray profile 500 with one or more monitored characteristics of the actual spray profile 800. The actual spray profile 800 is in one example observed with one or more spray sensors 124 included as a component of a feedback loop for the sprayer nozzle assembly control system 120.

The sprayer nozzle assembly control system 120 further includes the spray modulation interface 804. The spray modulation interface 804 receives one or more determined spray profile deviations determined with the comparator 802. The spray modulation interface 804 interprets the deviations and determines one or more control instructions that are supplied to associated modulating nozzle assemblies 110, also shown in FIG. 8. The modulating nozzle assemblies 110 optionally include all of the assemblies 110 provided along the sprayer booms 106 in FIG. 1, or one or more of the assemblies 110, for instance those assemblies associated with the spray sensor 124 observing a proximate actual spray profile 800. The spray modulation interface 804 optionally refines the control instructions based on the presence or absence of various spray modulation actuators. For instance, if one or more actuators are absent from the system the spray modulation interface 804 weights those control instructions to zero value and corresponding increases the weight of the control instructions for actuators that are available.

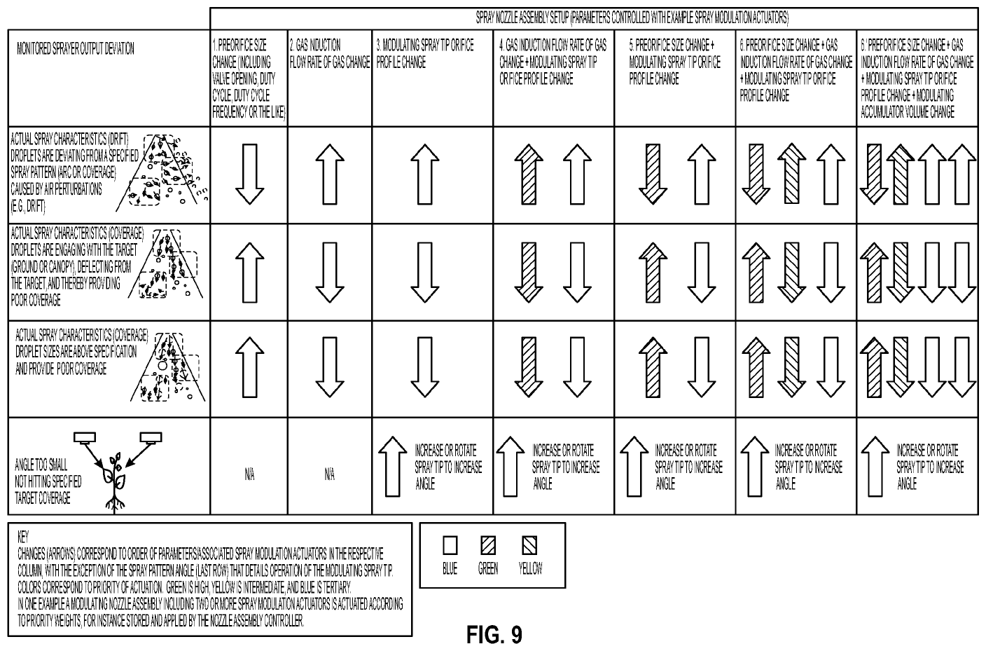

In other examples, the spray modulation interface 804 includes weights, priorities or the like that scale (e.g., as gains) the control instructions according to weight or priority given to various spray modulation actuators. For instance, a modulating spray tip is given a primary priority (e.g., with a gain of 1) while a control valve is given a secondary priority (e.g., with a gain of less than 1, such as 0.9, 0.5 or the like). In other examples, one or more of the spray modulation actuators are better suited to address various types of spray profile deviations. For instance, a modulating spray tip 312 is an example of a spray modulation actuator that is actuated to decrease droplet size precipitated with a spray profile deviation including a detected droplet deviation. In this example, a gas inductor 316 is better suited to decrease droplet size. Accordingly, the spray modulation interface 804 includes a biased weighting that favors the gas inductor (e.g., with a gain of 1) while the modulating spray tip 312 includes a lesser weighting (e.g., less than 1, such as 0.5). Examples of combinations of spray profile deviations, spray modulation actuators, example control instructions (and combinations of instructions) for the actuators, as well as priorities that optionally correspond to weighting are provided in FIG. 9.

The nozzle assembly 110 includes one or more spray modulation actuators including, but not limited to, a control valve 302, gas inductor 316, modulating spray tip 312 or modulating accumulator 314. In other examples, the nozzle assembly 110 includes or is associated with other potential spray modulation actuators that provide as a primary function or secondary function one or more of droplet control or spray pattern control of the actual spray profile 800. These other examples of spray modulation actuators include, but are not limited to, one or more of pumps that pressurize and deliver the agricultural product to the nozzle assemblies, pre-orifices proximate to the nozzle assemblies 110 or the like.

The control instructions generated by the spray modulation interface include one or more of pressure, gas induction, orifice, or accumulator instructions to actuate the associated spray modulation actuators associated with the modulating nozzle assembly 110 (e.g., various nozzle assemblies will have one or more actuators and not a full suite of actuators). In an example, pressure instructions include settings to raise, lower or maintain a system pressure or local pressure proximate to the nozzle assembly 110, for instance with control of a system pump, intermediate pump, the control valve 302 or the like. The pressure instructions include pressure values, pressure changes, duty cycles, duty cycle frequencies or the like. In one example, increase in pressure of the agricultural product generates finer droplets (e.g., decreases droplet size) and decrease in pressure generates coarse droplets (e.g., increases droplet size).

Control instructions in another example include gas induction flow rates for use with the gas inductor 316. The gas induction flow rates modulate the induction valve(s) 322 in FIG. 3A to constrain or permit the flow of induction gas to the assembly chamber 326 of the nozzle assembly 110. An increase in gas flow rate to the assembly chamber 326 increases droplet size (e.g., makes coarser), and conversely a decrease in gas flow rate to the assembly chamber 326 decreases droplet size (e.g., makes finer).

In another example, control instructions from the spray modulation interface 804 include one or more orifice instructions, such as orifice size, profile number, orifice plate positions or the like for use with the modulating spray tip 312. As previously shown in FIGS. 4A, B the modulating spray tip 312 includes a nozzle fitting 320 and associated fitting ports 400 that are movable relative to spray ports 318 of the spray tip housing 404. Variations in alignment cause changes in droplet size, and optionally spray pattern. For example, misalignment between the ports 400 and 318 contracts the size of the composite spray port and thereby decreases the droplet size (e.g., makes finer). Conversely, alignment between the ports 400 and 318 expands the size of the composite spray port and thereby increases the droplet size (e.g., makes coarser). In other examples, one or more of the spray ports 318 or the fitting ports 400 include angles, tapers, profiling or the like and variations in alignment of these features relative to the opposed ports 400 or 318 causes change in the spray pattern including narrowing, widening or the like. Optionally, control instructions are provided to the modulating spray tip 312 accomplish one or both of droplet size and spray pattern control. In other examples, instructions are provided to provide spray pattern control only or droplet size control only (e.g., through selective alignment and misalignment of portions of the ports 400, 318).

Optionally, the sprayer nozzle assembly control system 120 includes other sprayer modulation actuators remote from the modulating nozzle assemblies 110. One example of this type of actuator are boom height actuators. In this example, the spray modulation interface 804 provides control instructions including boom height adjustment, suspension height adjustment or the like to address target coverage deviations. Optionally, the boom height or suspension height are actuated in combination with spray pattern control (e.g., with the modulating spray tip 312) to enhance target coverage and thereby decrease target coverage deviations as previously discussed and shown with FIG. 7D.

In still other examples the control instructions to operate one or more of this spray modulation actuators include an accumulator volume or accumulator volume change instruction for the modulating accumulator 314. An instruction to increase the accumulator volume (e.g., with the telescoping accumulator body 328 in FIG. 3A) correspondingly increases droplet size (coarser), while an instruction to decrease the accumulator volume decreases droplet size (finer).

Implementation of the control instructions at the modulating nozzle assembly 110 (or with features such as pumps or the like associated with the assembly 110) changes one or more characteristics of the actual spray profile 800. For instance, as previously described herein, one or more of droplet size (including size range), spray pattern, target coverage, boom height, or the like are altered with the spray modulation actuators to address one or more determined spray profile deviations of the actual spray profile 800 relative to the specified spray profile 500. As control instructions are delivered, the actual spray profile 800 correspondingly changes, and the spray sensor 124 continues to monitor the actual spray profile 800 and facilitate the determination of updated deviations with the comparator 802 and the spray modulation interface 804.

FIG. 9 is a table of example parameter changes implemented with one or more modulating nozzle assemblies 110 equipped with one or more spray modulation actuators. The spray modulation actuators are described herein, and are configured to control one or more characteristics of an actual spray profile including, but not limited to, droplet size, spray pattern, associated droplet kinematics or the like. FIG. 9 provides a non-limiting list of the spray modulation actuators, combinations of actuators and a variety of spray profile deviations. FIG. 9 further provides examples, of control instructions implemented with each of the spray modulation actuators and combinations of the same for the various determined spray profile deviations. The spray modulation actuators are provided along the upper portion of the table (e.g., permutations 1 to 6 and 6′). The determined spray profile deviations are provided along the left portion of the table.

The example nozzle assembly controller 122 (see FIGS. 1 and 8) includes one or more algorithms, feedback controllers, operator or manufacturer specified parameter changes or the like that are implemented based on a combination of monitored sprayer profile deviations (examples are shown in FIGS. 7A-D and 9) and the available sprayer modulation actuators for the respective modulating nozzle assembly 110. Examples of parameter changes made based on sprayer profile deviations and example nozzle assembly setups are shown in FIG. 9 with corresponding arrows indicating one or more of increases, decreases or the like of the parameter (or parameters) associated with the respective spray modulation actuators.

In one example, the magnitude of spray modulation actuator changes, priority of modulation changes or the like (e.g., to orifice size, gas induction flow rate, pre-orifice size, accumulator volume or the like) are made according to one or more of operator or manufacturer preferences, algorithm based outputs, magnitude of deviation from the specified spray profile, type of deviation (or deviations) determined as part of the spray profile deviation or the like. In other examples, magnitude, priority or the like of the actuator control instructions are determined according to apportionment (e.g., weighting) between available spray modulation actuators of respective modulating nozzle assemblies. For example, as shown in various permutations of spray profile deviations with modulating nozzle assemblies 110 having two or more spray modulation actuators (e.g., columns for 4 to 6 and 6′) a priority of control is provided with green (first hatching) having a higher priority relative to yellow (second hatching), and yellow having a higher priority to blue (no hatching in the arrow). For example, with the modulating nozzle assembly 110 shown in column 4, having the gas inductor 316 and the modulating spray tip 312 priority is optionally set in this permutation with the gas inductor 316 control priority greater than the modulating spray tip 312 control. Accordingly, one or both of priority of modulation, magnitude of modulation or initial and secondary modulation is prioritized for the gas inductor 316 first and the modulating spray tip 312 second.

In another example, in column 6′ having a modulating nozzle assembly 110 with pre-orifice control (e.g., the control valve 302 or pump are actuated to control droplet and spray characteristics), the gas inductor 316, modulating spray tip 312 and the modulating accumulator 314 the nozzle assembly controller 122 of the sprayer nozzle assembly control system 120 prioritizes the actuators. For instance, the pre-orifice control is prioritized higher than the gas inductor 316, the gas inductor 316 is prioritized higher than each of the modulating spray tip 312 and the modulating accumulator 314, and the spray tip and accumulator have equal, matched or identical priorities. Accordingly, one or both of priority of modulation, magnitude of modulation or initial, secondary and tertiary (or greater) modulation is prioritized for the pre-orifice, the gas inductor 316, and the accumulator 314 and spray tip 312 in that order.

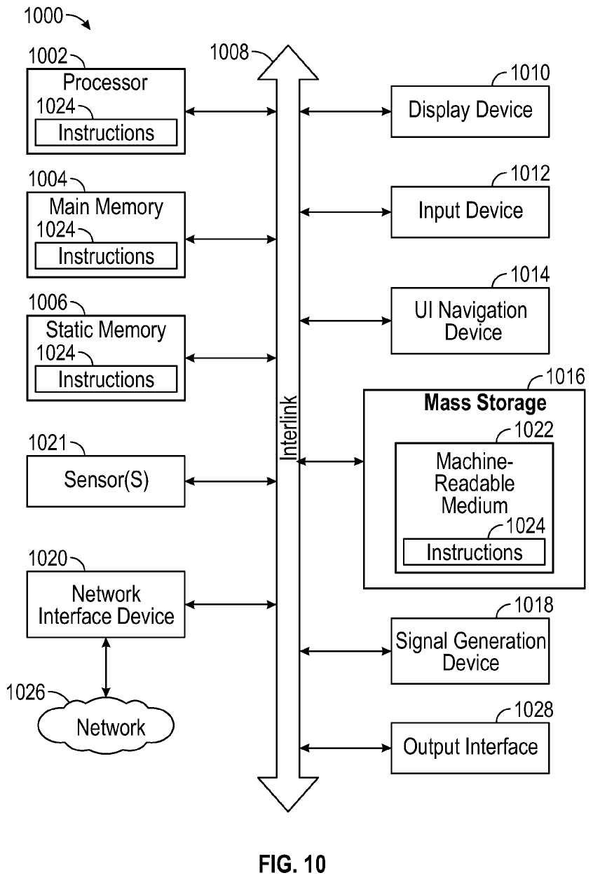

FIG. 10 illustrates a block diagram of an example computing machine 1000 upon which any one or more of the techniques (e.g., methodologies) discussed herein may perform. For instance, the sprayer nozzle assembly control system and its associated components are in one example included with the machine 1000. In alternative embodiments, the machine 1000 may operate as a standalone device or may be connected (e.g., networked) to other machines. In a networked deployment, the machine 1000 may operate in the capacity of a server machine, a client machine, or both in server-client network environments. In an example, the machine 1000 may act as a peer machine in peer-to-peer (P2P) (or other distributed) network environment. The machine 1000 may be a server, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. For example, a computing machine 1000 may be configured to implement the functionality of a spray nozzle assembly control system, agricultural vehicle including such a system or the like according to the examples provided herein. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms (hereinafter “modules”). Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations, such as the functions discussed with regard to the spray nozzle assembly control system and associated components herein. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 1000 may include a hardware processor 1002 (e.g., a central processing unit (CPU), a graphics processing unit (GPU), a hardware processor core, or any combination thereof), a main memory 1004 and a static memory 1006, some or all of which may communicate with each other via an interconnecting interface (e.g., bus, wiring, wireless connection, network or the like) 1008. The machine 1000 may further include a display unit 1010, an alphanumeric input device 1012 (e.g., a keyboard), and a user interface (UI) navigation device 1014 (e.g., a mouse). In an example, the display unit 1010, input device 1012 and UI navigation device 1014 may be a touch screen display. The machine 1000 may additionally include a storage device (e.g., drive unit) 1016, a signal generation device 1018 (e.g., a speaker, haptic feedback element or the like), a network interface device 1020, and one or more sensors 1021, such as a global positioning system (GPS) sensor, compass, accelerometer, or other sensor including the various example spray sensors described herein and their equivalents. The machine 1000 may include an output interface 1028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1016 may include a machine-readable medium 1022 that stores one or more sets of data structures or instructions 1024 (e.g., software) embodying or utilized by any one or more of the techniques or functions described herein. The instructions 1024 may also reside, completely or at least partially, within the main memory 1004, within static memory 1006, or within the hardware processor 1002 during execution thereof by the machine 1000. In an example, one or any combination of the hardware processor 1002, the main memory 1004, the static memory 1006, or the storage device 1016 may constitute machine-readable media.

While the machine-readable medium 1022 is illustrated as a single medium, the term “machine-readable medium” may include a single medium or multiple media (e.g., a centralized or distributed database, and/or associated caches and servers) configured to store the one or more instructions 1024.

The term “machine-readable medium” may include any medium that is capable of storing, encoding, or carrying instructions for execution by the machine 1000 and that cause the machine 1000 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine-readable media may include non-transitory machine-readable media. In some examples, machine-readable media may include machine-readable media that is not a transitory propagating signal.

One or more of the processor 1002, main memory 1004, static memory 1006, mass storage 1016 or the like in various examples are components of the spray nozzle assembly control system, for instance the nozzle assembly controller. As discussed herein, the nozzle assembly controller is in communication with sensors 1021, such as the spray sensors configured to observe the actual spray profile emanating from one or more of the spray tips of the modulating nozzle assemblies. The nozzle assembly controller (e.g., included as part of the processor 1002 and one or more memories) analyses observations from the sensors 1021, determines deviations from a specified spray profile (for instance stored in one of the machine 1000 memories) and conducts refinement of one or more spray modulation actuators interconnected with the machine 1000 for instance through the output interface 1028 or network interface device 1020. In other examples, nozzle assembly controller is connected with an alert device (e.g., the display device 1010, signal generation device 1018) to provide an alert to an operator or other autonomous system of the vehicle that the spray nozzle assembly control system has adjusted available spray modulation actuators to the maximum or minimum parameters and a spray profile deviation remains. For instance, the spray profile deviation is not fully correctable with the spray modulation actuators. In such an example, the operator or autonomous system conducts auxiliary operations including, but not limited to, change in vehicle speed, boom height, flow rates or the like to achieve a spray profile that provides adequate coverage to a target (e.g., crops, pests, plants, weeds, ground or the like).

In still other examples, the nozzle assembly controller is connected with an autonomous control system of the agricultural vehicle to automatically address uncorrected spray profile deviations (e.g., outside of the range of correction provided by the spray modulation actuators). The autonomous control system is connected through one or more of the interface 1008, or interfaces 1020, 1028 and provides automated control of the vehicle speed, boom height, flow rates or the like to achieve a spray profile that provides adequate coverage to a target.

In other examples, the instructions 1024 for the machine 1000, for instance including the sprayer nozzle assembly control system, may further be transmitted or received over a communications network 1026 using a transmission medium via the network interface device 1020. The machine 1000 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 1020 may include one or more physical jacks (e.g., Ethernet, coaxial, or phone jacks) or one or more antennas to connect to the communications network 1026. In an example, the network interface device 1020 may include a plurality of antennas to wirelessly communicate using at least one of single-input multiple-output (SIMO), multiple-input multiple-output (MIMO), or multiple-input single-output (MISO) techniques. In some examples, the network interface device 1020 may wirelessly communicate using Multiple User MIMO techniques.

### Various Notes and Aspects

Aspect 1 can include subject matter such as a sprayer nozzle assembly control system comprising: a modulating nozzle assembly configured to spray an agricultural product, the modulating nozzle assembly includes: a control valve configured to control at least a flow rate of the agricultural product; a spray tip in communication with the control valve, the spray tip configured to spray the agricultural product; and at least one spray modulation actuator included with one or both of the control valve or the spray tip, the spray modulation actuator is configured to control an actual spray profile of the sprayed agricultural product; a spray sensor configured to monitor the actual spray profile of the spray tip; and a nozzle assembly controller in communication with the spray sensor, the nozzle assembly controller configured to control modulation of the actual spray profile, the nozzle assembly controller includes: a comparator configured to compare the actual spray profile with a specified spray profile and generate a spray profile deviation based on the comparison; and a spray modulation interface in communication with the at least one spray modulation actuator, the spray modulation interface directs actuation of the at least one spray modulation actuator to modulate the actual spray profile and decrease the spray profile deviation.

Aspect 2 can include, or can optionally be combined with the subject matter of Aspect 1, to optionally include wherein the modulating nozzle assembly includes a plurality of modulating nozzle assemblies, and each of the modulating nozzle assemblies is in communication with the nozzle assembly controller.

Aspect 3 can include, or can optionally be combined with the subject matter of one or any combination of Aspects 1 or 2 to optionally include wherein the nozzle assembly controller includes a plurality of nozzle assembly controllers, and each of the modulating nozzle assemblies is in communication with an associated nozzle assembly controller of the plurality of nozzle assembly controllers.

Aspect 4 can include, or can optionally be combined with the subject matter of one or any combination of Aspects 1-3 to optionally include wherein the spray sensor includes one or more of a camera or video camera, ultrasound sensor, laser sensor, LIDAR sensor or radar sensor, and the spray sensor is configured to monitor the actual spray profiles of the plurality of modulating nozzle assemblies.

Aspect 5 can include, or can optionally be combined with the subject matter of one or any combination of Aspects 1-4 to optionally include wherein the at least one spray modulation actuator includes one or more of an agricultural product pump configured to pump the agricultural product, the control valve, an air inductor coupled with the modulating nozzle assembly, the spray tip including a modulating spray tip, or a modulating accumulator.

Aspect 6 can include, or can optionally be combined with the subject matter of Aspects 1-5 to optionally include wherein the at least one spray modulation actuator includes the control valve, and the control valve includes a solenoid operated control valve with a valve poppet.

Aspect 7 can include, or can optionally be combined with the subject matter of Aspects 1-6 to optionally include, wherein the spray modulation interface directs actuation of the control valve to a first duty cycle for the spray profile deviation indicating a droplet size proximate to a specified droplet size of the specified spray profile; and the spray modulation interface directs actuation of the control valve to a second duty cycle greater than the first duty cycle for the spray profile deviation indicating the droplet size is greater than the specified droplet size of the specified spray profile.

Aspect 8 can include, or can optionally be combined with the subject matter of Aspects 1-7 to optionally include wherein the spray modulation interface directs actuation of the control valve to a first duty cycle for the spray profile deviation indicating droplets are within a specified spray pattern of the specified spray profile; and the spray modulation interface directs actuation of the control valve to a second duty cycle less than the first duty cycle for the spray profile deviation indicating the droplets are outside of the specified spray pattern of the specified spray profile.

Aspect 9 can include, or can optionally be combined with the subject matter of Aspects 1-8 to optionally include wherein the spray tip includes a modulating spray tip, and the at least one spray modulation actuator includes the modulating spray tip; and the modulating spray tip includes: a spray tip housing including one or more spray ports; a nozzle fitting movably coupled with the spray tip housing, the nozzle fitting including one or more fitting ports movable relative to the one or more spray ports; and a fitting actuator coupled with the nozzle fitting, the fitting actuator is configured to move the nozzle fitting relative to the spray tip and accordingly move the one or more fitting ports relative to the one or more spray ports.

Aspect 10 can include, or can optionally be combined with the subject matter of Aspects 1-9 to optionally include wherein the nozzle fitting movably coupled with the spray tip housing includes the nozzle fitting rotatably coupled with the spray tip housing.

Aspect 11 can include, or can optionally be combined with the subject matter of Aspects 1-10 to optionally include wherein one or more spray ports of the spray tip have a spray port profile, and the one or more fitting ports of the nozzle fitting have a fitting port profile at an angle relative to the spray port profile.

Aspect 12 can include, or can optionally be combined with the subject matter of Aspects 1-11 to optionally include wherein the spray modulation interface directs actuation of the nozzle fitting to a first position relative to the spray tip for the spray profile deviation indicating a droplet size proximate to a specified droplet size of the specified spray profile; and the spray modulation interface directs actuation of the nozzle fitting to a second position relative to the first position to decrease alignment of the spray ports and the fitting ports for the spray profile deviation indicating the droplet size is greater than the specified droplet size of the specified spray profile.

Aspect 13 can include, or can optionally be combined with the subject matter of Aspects 1-12 to optionally include wherein the spray modulation interface directs actuation of the nozzle fitting to a first position relative to the spray tip for the spray profile deviation indicating droplets are within a specified spray pattern of the specified spray profile; and the spray modulation interface directs actuation of the nozzle fitting to a second position relative to the first position to increase alignment of the spray ports and the fitting ports for the spray profile deviation indicating the droplets are outside of the specified spray pattern of the specified spray profile.

Aspect 14 can include, or can optionally be combined with the subject matter of Aspects 1-13 to optionally include wherein the at least one spray modulation actuator includes a gas inductor in communication with an assembly chamber of the modulating nozzle assembly between the spray tip and the control valve; and the gas inductor includes: a gas port in communication with the assembly chamber; and an inductor control valve configured to throttle a flow rate of a gas through the gas port for fixing with the agricultural product in the assembly chamber.

Aspect 15 can include, or can optionally be combined with the subject matter of Aspects 1-14 to optionally include wherein the spray modulation interface directs actuation of the gas inductor to a first gas flow rate for the spray profile deviation indicating a droplet size proximate to a specified droplet size of the specified spray profile; and the spray modulation interface directs actuation of the gas inductor to a second gas flow rate less than the first gas flow rate for the spray profile deviation indicating the droplet size is greater than the specified droplet size of the specified spray profile.

Aspect 16 can include, or can optionally be combined with the subject matter of Aspects 1-15 to optionally include wherein the spray modulation interface directs actuation of the gas inductor to a first gas flow rate for the spray profile deviation indicating droplets are within a specified spray pattern of the specified spray profile; and the spray modulation interface directs actuation of the gas inductor to a second gas flow rate greater than the first gas flow rate for the spray profile deviation indicating the droplets are outside of the specified spray pattern of the specified spray profile.

Aspect 17 can include, or can optionally be combined with the subject matter of Aspects 1-16 to optionally include wherein the modulating nozzle assembly includes an assembly chamber between the spray tip and the control valve; and the at least one spray modulation actuator includes a modulating accumulator with the assembly chamber, the modulating accumulator includes: a telescoping accumulator body as a portion of the of the assembly chamber, the telescoping accumulator body configured to modulate the volume of the assembly chamber; and an accumulator actuator coupled with the telescoping accumulator body and configured to expand or compress the telescoping accumulator body.

Aspect 18 can include, or can optionally be combined with the subject matter of Aspects 1-17 to optionally include wherein the spray modulation interface directs actuation of the modulating accumulator to a first assembly chamber volume for the spray profile deviation indicating a droplet size proximate to a specified droplet size of the specified spray profile; and The spray modulation interface directs actuation of the modulating accumulator to a second assembly chamber volume less than the first assembly chamber volume for the spray profile deviation indicating the droplet size is greater than the specified droplet size of the specified spray profile.

Aspect 19 can include, or can optionally be combined with the subject matter of Aspects 1-18 to optionally include wherein the spray modulation interface directs actuation of the modulating accumulator to a first assembly chamber volume for the spray profile deviation indicating droplets are within a specified spray pattern of the specified spray profile; and the spray modulation interface directs actuation of the modulating accumulator to a second assembly chamber volume greater than the first assembly chamber volume for the spray profile deviation indicating the droplets are outside of the specified spray pattern of the specified spray profile.

Aspect 20 can include, or can optionally be combined with the subject matter of Aspects 1-19 to optionally include a sprayer nozzle assembly control system comprising: a modulating nozzle assembly configured to spray an agricultural product, the modulating nozzle assembly includes: a control valve configured to control at least a flow rate of the agricultural product; and a spray tip in communication with the control valve, the spray tip configured to spray the agricultural product; a spray sensor configured to monitor an actual spray profile of the sprayed agricultural product from the spray tip; and a nozzle assembly controller in communication with the spray sensor, the nozzle assembly controller configured to control modulation of the actual spray profile, the nozzle assembly controller includes: a comparator configured to compare the actual spray profile with a specified spray profile and generate a spray profile deviation based on the comparison; and a spray modulation interface in communication with the control valve, the spray modulation interface directs actuation of the control valve to modulate the actual spray profile and decrease the spray profile deviation.

Aspect 21 can include, or can optionally be combined with the subject matter of Aspects 1-20 to optionally include at least one spray modulation actuator configured to control the actual spray profile of the of the sprayed agricultural product.

Aspect 22 can include, or can optionally be combined with the subject matter of Aspects 1-21 to optionally include wherein the at least one spray modulation actuator includes the control valve.

Aspect 23 can include, or can optionally be combined with the subject matter of Aspects 1-22 to optionally include wherein the spray modulation interface directs actuation of the at least one spray modulation actuator to control component actual spray characteristics of the actual spray profile including one or more of droplet size, droplet size range, droplet size ratio, droplet kinematics, or spray pattern.

Aspect 24 can include, or can optionally be combined with the subject matter of Aspects 1-23 to optionally include wherein the spray modulation interface includes at least one algorithm configured to direct actuation of the at least one spray modulation actuator to control the actual spray profile.

Aspect 25 can include, or can optionally be combined with the subject matter of Aspects 1-24 to optionally include wherein the at least one algorithm includes one or more of a feedback control algorithm, library of spray modulation instructions, prioritization of the at least one spray modulation actuator, apportionment of the at least one spray modulation actuator, operator preference, manufacturer preference, or weighting of the least one spray modulation actuator.

Aspect 26 can include, or can optionally be combined with the subject matter of Aspects 1-25 to optionally include wherein the spray tip includes a modulating spray tip, and the at least one spray modulation actuator includes the modulating spray tip; and wherein the spray modulation interface is in communication with the modulating spray tip, the spray modulation interface directs actuation of the modulating spray tip to modulate the actual spray profile and decrease the spray profile deviation.

Aspect 27 can include, or can optionally be combined with the subject matter of Aspects 1-26 to optionally include wherein the modulating spray tip includes: a spray tip housing including one or more spray ports; a nozzle fitting movably coupled with the spray tip housing, the nozzle fitting including one or more fitting ports movable relative to the one or more spray ports; and a fitting actuator coupled with the nozzle fitting, the fitting actuator is configured to move the nozzle fitting relative to the spray tip and accordingly move the one or more fitting ports relative to the one or more spray ports.

Aspect 28 can include, or can optionally be combined with the subject matter of Aspects 1-27 to optionally include wherein the at least one spray modulation actuator includes a gas inductor in communication with an assembly chamber of the modulating nozzle assembly between the spray tip and the control valve; and wherein the spray modulation interface is in communication with the gas inductor, the spray modulation interface directs actuation of the gas inductor to modulate the actual spray profile and decrease the spray profile deviation.

Aspect 29 can include, or can optionally be combined with the subject matter of Aspects 1-28 to optionally include wherein the gas inductor includes: a gas port in communication with the assembly chamber; and an inductor control valve configured to throttle a flow rate of a gas through the gas port for fixing with the agricultural product in the assembly chamber.

Aspect 30 can include, or can optionally be combined with the subject matter of Aspects 1-29 to optionally include wherein the at least one spray modulation actuator includes a modulating accumulator with an assembly chamber of the modulating nozzle assembly; and wherein the spray modulation interface is in communication with the modulating accumulator, the spray modulation interface directs actuation of the modulating accumulator to modulate the actual spray profile and decrease the spray profile deviation.

Aspect 31 can include, or can optionally be combined with the subject matter of Aspects 1-30 to optionally include wherein the modulating accumulator includes: a telescoping accumulator body as a portion of the of the assembly chamber, the telescoping accumulator body configured to modulate the volume of the assembly chamber; and an accumulator actuator coupled with the telescoping accumulator body and configured to expand or compress the telescoping accumulator body.

Aspect 32 can include, or can optionally be combined with the subject matter of Aspects 1-31 to optionally include wherein the spray sensor includes one or more of a camera or video camera, ultrasound sensor, laser sensor, LIDAR sensor or radar sensor.

Aspect 33 can include, or can optionally be combined with the subject matter of Aspects 1-32 to optionally include wherein the specified spray profile includes one or more component specified spray characteristics including droplet size, droplet size range, droplet size ratio, droplet kinematics, droplet position, droplet speed, droplet velocity, droplet acceleration, spray pattern, target coverage.

Aspect 34 can include, or can optionally be combined with the subject matter of Aspects 1-33 to optionally include wherein target coverage includes one or more of application to a portion of a spray target, application to a target height of the spray target, or application at a boom height of a sprayer boom or the modulating nozzle assembly.

Aspect 35 can include, or can optionally be combined with the subject matter of Aspects 1-34 to optionally include wherein the spray sensor is configured to monitor component actual spray characteristics of the actual spray profile corresponding to the component specified spray characteristics of the specified spray profile.

Aspect 36 can include, or can optionally be combined with the subject matter of Aspects 1-35 to optionally include wherein the spray sensor is configured to monitor one or more of a target height of a spray target, or a boom height of a sprayer boom or the modulating nozzle assembly.

Aspect 37 can include, or can optionally be combined with the subject matter of Aspects 1-36 to optionally include a method for controlling a sprayer nozzle assembly comprising: monitoring an actual spray profile of a spray tip of at least one modulating nozzle assembly with a spray sensor; determining a spray profile deviation of the actual spray profile relative to a specified spray profile, determining includes: comparing the actual spray profile with the specified spray profile; and generating a spray profile deviation based on the comparison; actuating one or more spray modulation actuators associated with the modulating nozzle assembly to modulate the actual spray profile and decrease the spray profile deviation.

Aspect 38 can include, or can optionally be combined with the subject matter of Aspects 1-37 to optionally include wherein the spray sensor includes one or more of a camera or video camera; and monitoring the actual spray profile with a spray sensor includes: identifying one or more droplets within the actual spray profile; and tracking the identified droplets.

Aspect 39 can include, or can optionally be combined with the subject matter of Aspects 1-38 to optionally include wherein comparing the actual spray profile with the specified spray profile includes comparing the identified and tracked one or more droplets with corresponding characteristics of the specified spray profile.

Aspect 40 can include, or can optionally be combined with the subject matter of Aspects 1-39 to optionally include wherein each of the specified spray profile and the actual spray profile include component actual and specified spray characteristics; and comparing the actual spray profile with the specified spray profile includes comparing the component actual spray characteristics with corresponding component specified spray characteristics.

Aspect 41 can include, or can optionally be combined with the subject matter of Aspects 1-40 to optionally include wherein monitoring the actual spray profile of the spray tip includes monitoring target coverage, and target coverage includes one or more of application to a portion of a spray target, application to a target height of the spray target, or application at a boom height of a sprayer boom or the modulating nozzle assembly.

Aspect 42 can include, or can optionally be combined with the subject matter of Aspects 1-41 to optionally include wherein actuating the one or more spray modulation actuators associated with the modulating nozzle assembly to modulate the actual spray profile and decrease the spray profile deviation includes modulating one or more of a droplet size, droplet size range, droplet size ratio, droplet kinematics, or spray pattern.

Aspect 43 can include, or can optionally be combined with the subject matter of Aspects 1-42 to optionally include wherein actuating the one or more spray modulation actuators associated with the modulating nozzle assembly to modulate the actual spray profile and decrease the spray profile deviation includes actuating the one or more spray modulation actuators according to one or more of: the spray profile deviation magnitude; and the spray profile deviation of one or more component actual spray characteristics and corresponding component specified spray characteristics.

Aspect 44 can include, or can optionally be combined with the subject matter of Aspects 1-43 to optionally include wherein actuating the one or more spray modulation actuators associated with the modulating nozzle assembly includes one or more of modulating an agricultural product pressure proximate to the modulating nozzle assembly, modulating an orifice profile of the spray tip, modulating a gas flow rate of a gas inductor to the agricultural product or modulating an assembly chamber volume.

Aspect 45 can include, or can optionally be combined with the subject matter of Aspects 1-44 to optionally include wherein the one or more spray modulation actuators include one or more of a control valve, a gas inductor, a modulating spray tip as the spray tip, or a modulating accumulator.

Aspect 46 can include, or can optionally be combined with the subject matter of Aspects 1-45 to optionally include wherein actuating one or more spray modulation actuators associated with the modulating nozzle assembly includes modulating two or more spray modulation actuators in combination. Aspect 47 can include, or can optionally be combined with the subject matter of Aspects 1-46 to optionally include wherein the spray profile deviation corresponds to one or more of spray drift, spray deflection, droplet size deviation, or target coverage.

Aspect 48 can include, or can optionally be combined with the subject matter of Aspects 1-47 to optionally include wherein the at least one modulating nozzle assembly includes a plurality of modulating nozzle assemblies positioned along a sprayer boom from an interior boom portion to a peripheral boom portion; wherein the determined spray profile deviation includes spray drift; and comprising: arresting spraying from modulating nozzle assemblies proximate to the peripheral boom portion; and increasing agricultural product flow rate to the modulating nozzle assemblies proximate to the interior boom portion.

Aspect 49 can include, or can optionally be combined with the subject matter of Aspects 1-48 to optionally include wherein actuating the one or more spray modulation actuators associated with the modulating nozzle assembly includes actuating the one or more spray modulation actuators of the modulating nozzle assemblies proximate to the interior boom portion to decrease a droplet size of the respective actual spray profiles and promote spray drift.

Each of these non-limiting aspects can stand on its own, or can be combined in various permutations or combinations with one or more of the other aspects.

The above description includes references to the accompanying drawings, which form a part of the detailed description. The drawings show, by way of illustration, specific embodiments in which the invention can be practiced. These embodiments are also referred to herein as “aspects” or “examples.” Such aspects or example can include elements in addition to those shown or described. However, the present inventors also contemplate aspects or examples in which only those elements shown or described are provided. Moreover, the present inventors also contemplate aspects or examples using any combination or permutation of those elements shown or described (or one or more features thereof), either with respect to a particular aspects or examples (or one or more features thereof), or with respect to other Aspects (or one or more features thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

Method aspects or examples described herein can be machine or computer-implemented at least in part. Some aspects or examples can include a computer-readable medium or machine-readable medium encoded with instructions operable to configure an electronic device to perform methods as described in the above aspects or examples. An implementation of such methods can include code, such as microcode, assembly language code, a higher-level language code, or the like. Such code can include computer readable instructions for performing various methods. The code may form portions of computer program products. Further, in an aspect or example, the code can be tangibly stored on one or more volatile, non-transitory, or non-volatile tangible computer-readable media, such as during execution or at other times. Aspects or examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described aspects or examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as aspects, examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A sprayer nozzle assembly control system comprising:
a modulating nozzle assembly configured to spray an agricultural product, the modulating nozzle assembly includes:
a control valve configured to control at least a flow rate of the agricultural product;
a spray tip in communication with the control valve, the spray tip configured to spray the agricultural product; and
at least one spray modulation actuator included with one or both of the control valve or the spray tip, the spray modulation actuator is configured to control an actual spray profile of the sprayed agricultural product;
a spray sensor configured to monitor the actual spray profile of the spray tip; and
a nozzle assembly controller in communication with the spray sensor, the nozzle assembly controller configured to control modulation of the actual spray profile, the nozzle assembly controller includes:
a comparator configured to compare the actual spray profile with a specified spray profile and generate a spray profile deviation based on the comparison; and
a spray modulation interface in communication with the at least one spray modulation actuator, the spray modulation interface directs actuation of the at least one spray modulation actuator to modulate the actual spray profile and decrease the spray profile deviation.

2. (canceled)

3. (canceled)

4. The sprayer nozzle assembly control system of claim 1, wherein the spray sensor includes one or more of a camera, video camera, ultrasound sensor, laser sensor, LIDAR sensor or radar sensor, and the spray sensor is configured to monitor the actual spray profiles of the plurality of modulating nozzle assemblies.

5. The sprayer nozzle assembly control system of claim 1, wherein the at least one spray modulation actuator includes one or more of an agricultural product pump configured to pump the agricultural product, the control valve, an air inductor coupled with the modulating nozzle assembly, the spray tip including a modulating spray tip, or a modulating accumulator.

6. The sprayer nozzle assembly control system of claim 1, wherein the at least one spray modulation actuator includes the control valve, and the control valve includes a solenoid operated control valve with a valve poppet.

7. The sprayer nozzle assembly control system of claim 6, wherein the spray modulation interface directs actuation of the control valve to a first duty cycle for the spray profile deviation indicating a droplet size proximate to a specified droplet size of the specified spray profile; and
the spray modulation interface directs actuation of the control valve to a second duty cycle greater than the first duty cycle for the spray profile deviation indicating the droplet size is greater than the specified droplet size of the specified spray profile.

8. The sprayer nozzle assembly control system of claim 6, wherein the spray modulation interface directs actuation of the control valve to a first duty cycle for the spray profile deviation indicating droplets are within a specified spray pattern of the specified spray profile; and
The spray modulation interface directs actuation of the control valve to a second duty cycle less than the first duty cycle for the spray profile deviation indicating the droplets are outside of the specified spray pattern of the specified spray profile.

9. The sprayer nozzle assembly control system of claim 1, wherein the spray tip includes a modulating spray tip, and the at least one spray modulation actuator includes the modulating spray tip; and
the modulating spray tip includes:
a spray tip housing including one or more spray ports;
a nozzle fitting movably coupled with the spray tip housing, the nozzle fitting including one or more fitting ports movable relative to the one or more spray ports; and
a fitting actuator coupled with the nozzle fitting, the fitting actuator is configured to move the nozzle fitting relative to the spray tip and accordingly move the one or more fitting ports relative to the one or more spray ports.

10. (canceled)

11. (canceled)

12. The sprayer nozzle assembly control system of claim 9, wherein the spray modulation interface directs actuation of the nozzle fitting to a first position relative to the spray tip for the spray profile deviation indicating a droplet size proximate to a specified droplet size of the specified spray profile; and
the spray modulation interface directs actuation of the nozzle fitting to a second position relative to the first position to decrease alignment of the spray ports and the fitting ports for the spray profile deviation indicating the droplet size is greater than the specified droplet size of the specified spray profile.

13. The sprayer nozzle assembly control system of claim 9, wherein the spray modulation interface directs actuation of the nozzle fitting to a first position relative to the spray tip for the spray profile deviation indicating droplets are within a specified spray pattern of the specified spray profile; and
the spray modulation interface directs actuation of the nozzle fitting to a second position relative to the first position to increase alignment of the spray ports and the fitting ports for the spray profile deviation indicating the droplets are outside of the specified spray pattern of the specified spray profile.

14-19. (canceled)

20. A sprayer nozzle assembly control system comprising:
a modulating nozzle assembly configured to spray an agricultural product, the modulating nozzle assembly includes:
a control valve configured to control at least a flow rate of the agricultural product; and
a spray tip in communication with the control valve, the spray tip configured to spray the agricultural product;
a spray sensor configured to monitor an actual spray profile of the sprayed agricultural product from the spray tip; and
a nozzle assembly controller in communication with the spray sensor, the nozzle assembly controller configured to control modulation of the actual spray profile, the nozzle assembly controller includes:
a comparator configured to compare the actual spray profile with a specified spray profile and generate a spray profile deviation based on the comparison; and
a spray modulation interface in communication with the control valve, the spray modulation interface directs actuation of the control valve to modulate the actual spray profile and decrease the spray profile deviation.

21. The sprayer nozzle assembly control system of claim 20 comprising at least one spray modulation actuator configured to control the actual spray profile of the of the sprayed agricultural product.

22. (canceled)

23. The sprayer nozzle assembly control system of claim 21, wherein the spray modulation interface directs actuation of the at least one spray modulation actuator to control component actual spray characteristics of the actual spray profile including one or more of droplet size, droplet size range, droplet size ratio, droplet kinematics, or spray pattern.

24. The sprayer nozzle assembly control system of claim 21, wherein the spray modulation interface includes at least one algorithm configured to direct actuation of the at least one spray modulation actuator to control the actual spray profile.

25. The sprayer nozzle assembly control system of claim 24, wherein the at least one algorithm includes one or more of a feedback control algorithm, library of spray modulation instructions, prioritization of the at least one spray modulation actuator, apportionment of the at least one spray modulation actuator, operator preference, manufacturer preference, or weighting of the least one spray modulation actuator.

26. The sprayer nozzle assembly control system of claim 21, wherein the spray tip includes a modulating spray tip, and the at least one spray modulation actuator includes the modulating spray tip; and
wherein the spray modulation interface is in communication with the modulating spray tip, the spray modulation interface directs actuation of the modulating spray tip to modulate the actual spray profile and decrease the spray profile deviation.

27. The sprayer nozzle assembly control system of claim 26, wherein the modulating spray tip includes:
a spray tip housing including one or more spray ports;
a nozzle fitting movably coupled with the spray tip housing, the nozzle fitting including one or more fitting ports movable relative to the one or more spray ports; and
a fitting actuator coupled with the nozzle fitting, the fitting actuator is configured to move the nozzle fitting relative to the spray tip and accordingly move the one or more fitting ports relative to the one or more spray ports.

28. The sprayer nozzle assembly control system of claim 21, wherein the at least one spray modulation actuator includes a gas inductor in communication with an assembly chamber of the modulating nozzle assembly between the spray tip and the control valve; and
wherein the spray modulation interface is in communication with the gas inductor, the spray modulation interface directs actuation of the gas inductor to modulate the actual spray profile and decrease the spray profile deviation.

29. (canceled)

30. The sprayer nozzle assembly control system of claim 21, wherein the at least one spray modulation actuator includes a modulating accumulator with an assembly chamber of the modulating nozzle assembly; and
wherein the spray modulation interface is in communication with the modulating accumulator, the spray modulation interface directs actuation of the modulating accumulator to modulate the actual spray profile and decrease the spray profile deviation.

31. (canceled)

32. (canceled)

33. The sprayer nozzle assembly control system of claim 20, wherein the specified spray profile includes one or more component specified spray characteristics including droplet size, droplet size range, droplet size ratio, droplet kinematics, droplet position, droplet speed, droplet velocity, droplet acceleration, spray pattern, target coverage.

34. The sprayer nozzle assembly control system of claim 33, wherein target coverage includes one or more of application to a portion of a spray target, application to a target height of the spray target, or application at a boom height of a sprayer boom or the modulating nozzle assembly.

35. The sprayer nozzle assembly control system of claim 33, wherein the spray sensor is configured to monitor component actual spray characteristics of the actual spray profile corresponding to the component specified spray characteristics of the specified spray profile.

36. The sprayer nozzle assembly control system of claim 20, wherein the spray sensor is configured to monitor one or more of a target height of a spray target, or a boom height of a sprayer boom or the modulating nozzle assembly.

37. A method for controlling a sprayer nozzle assembly comprising:
monitoring an actual spray profile of a spray tip of at least one modulating nozzle assembly with a spray sensor;
determining a spray profile deviation of the actual spray profile relative to a specified spray profile, determining includes:
comparing the actual spray profile with the specified spray profile; and
generating a spray profile deviation based on the comparison;
actuating one or more spray modulation actuators associated with the modulating nozzle assembly to modulate the actual spray profile and decrease the spray profile deviation.

38. The method of claim 37, wherein the spray sensor includes one or more of a camera or video camera; and monitoring the actual spray profile with a spray sensor includes:
identifying one or more droplets within the actual spray profile; and
tracking the identified droplets.

39. The method of claim 38, wherein comparing the actual spray profile with the specified spray profile includes comparing the identified and tracked one or more droplets with corresponding characteristics of the specified spray profile.

40. The method of claim 37, wherein each of the specified spray profile and the actual spray profile include component actual and specified spray characteristics; and
comparing the actual spray profile with the specified spray profile includes comparing the component actual spray characteristics with corresponding component specified spray characteristics.

41. The method of claim 37, wherein monitoring the actual spray profile of the spray tip includes monitoring target coverage, and target coverage includes one or more of application to a portion of a spray target, application to a target height of the spray target, or application at a boom height of a sprayer boom or the modulating nozzle assembly.

42. The method of claim 37, wherein actuating the one or more spray modulation actuators associated with the modulating nozzle assembly to modulate the actual spray profile and decrease the spray profile deviation includes modulating one or more of a droplet size, droplet size range, droplet size ratio, droplet kinematics, or spray pattern.

43. The method of claim 37, wherein actuating the one or more spray modulation actuators associated with the modulating nozzle assembly to modulate the actual spray profile and decrease the spray profile deviation includes actuating the one or more spray modulation actuators according to one or more of:
the spray profile deviation magnitude; and
the spray profile deviation of one or more component actual spray characteristics and corresponding component specified spray characteristics.

44. The method of claim 37, wherein actuating the one or more spray modulation actuators associated with the modulating nozzle assembly includes one or more of modulating an agricultural product pressure proximate to the modulating nozzle assembly, modulating an orifice profile of the spray tip, modulating a gas flow rate of a gas inductor to the agricultural product or modulating an assembly chamber volume.

45. (canceled)

46. (canceled)

47. The method of claim 37, wherein the spray profile deviation corresponds to one or more of spray drift, spray deflection, droplet size deviation, or target coverage.

48. The method of claim 37, wherein the at least one modulating nozzle assembly includes a plurality of modulating nozzle assemblies positioned along a sprayer boom from an interior boom portion to a peripheral boom portion;
wherein the determined spray profile deviation includes spray drift; and comprising:
arresting spraying from modulating nozzle assemblies proximate to the peripheral boom portion; and
increasing agricultural product flow rate to the modulating nozzle assemblies proximate to the interior boom portion.

49. (canceled)
